(19) United States
(12) Patent Application Publication
(10) Pub. No.: US 2025/0365381 A1
(43) Pub. Date: Nov. 27, 2025

(54) IMAGE PROCESSING APPARATUS, METHOD, AND NON-TRANSITORY COMPUTER-READABLE STORAGE MEDIUM

(71) Applicant: CANON KABUSHIKI KAISHA, Tokyo (JP)

(72) Inventor: ASAMI ITO, Kanagawa (JP)

(21) Appl. No.: 19/206,425

(22) Filed: May 13, 2025

(30) Foreign Application Priority Data
May 24, 2024 (JP) 2024-085150

(51) Int. Cl. H04N 1/327; H04N 1/00

(52) U.S. Cl. CPC H04N 1/32765; H04N 1/00973

(57) ABSTRACT

Scan settings are preliminarily exported from an image processing apparatus and are then registered with an easy scan application of a client terminal. The client terminal accepts an input for issuing an instruction including scan processing to a nearby image processing apparatus, establishes a communication connection with the nearby image processing apparatus, and passes an instruction including scan settings which are managed by the easy scan application to the image processing apparatus. Then, the client terminal receives, from the image processing apparatus, data obtained by scan processing performed based on the scan settings.

### BACKGROUND

### Field of the Disclosure

Aspects of the present disclosure generally relate to processing of data which is scanned by an image processing apparatus.

### Description of the Related Art

Recently, due to the diversification of places to work, the number of people who perform work not only at their own offices but also while using coworking spaces or at shared offices has been increasing. Moreover, there are, as ever, opportunities in which people work at places different from places where people are always working, such as by travelling on business to different business offices. In such situations, a user needs to operate not an image processing apparatus which the user is always using but an image processing apparatus which the user uses for the first time.

Japanese Patent Application Laid-Open No. 2022-135460 discusses a technique in which an image processing apparatus acquires, from a client terminal previously registered with the image processing apparatus, scan settings corresponding to the orientation or size of an original, thus facilitating scan settings in the image processing apparatus.

However, such a technique requires the implementation of registering a client terminal with an image processing apparatus, so that, with respect to an image processing apparatus which a user uses for the first time, first, the user has to perform registration work, which is troublesome task. Particularly, in the case of an image processing apparatus which the user may use only once, such registration work may be burdensome to the user. Therefore, a system in which, even with respect to an image processing apparatus which the user uses for the first time, the user is enabled to easily issue, via a client terminal, an instruction to the image processing apparatus to perform scanning can be expected. In such a system, with respect to scanning which is performed in, for example, routine work, a contrivance for saving time and effort for an operation or for preventing erroneous settings is desired.

### SUMMARY

According to an aspect of the present disclosure, an image processing apparatus including a scanner includes a connection unit configured to, in response to a connection request from an information processing apparatus which lies close to the image processing apparatus and which has an application for issuing an instruction to an image processing apparatus including a scanner installed thereon, establish a communication connection with the information processing apparatus, a reception unit configured to receive, from the information processing apparatus, an instruction including scan settings which are managed by the application selected by a user in the information processing apparatus with which the communication connection has been established, an acceptance unit configured to accept a user instruction for performing scan processing using the received scan settings, and a processing unit configured to, in response to the user instruction being accepted, perform scan processing based on the scan settings and transmit data obtained by the scan processing to the information processing apparatus.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a system according to a first exemplary embodiment.

FIG. 2 is a diagram illustrating an example of particulars of a controller unit included in an image processing apparatus.

FIG. 3 is a block diagram illustrating an example of particulars of a client terminal.

FIG. 4 is a block diagram illustrating an example of a software configuration of the image processing apparatus.

FIG. 5 is a block diagram illustrating an example of a software configuration of the client terminal.

FIG. 6 is a diagram illustrating an example of a sequence representing preprocessing in the first exemplary embodiment.

FIGS. 7A, 7B, 7C, 7D, and 7E are diagrams illustrating examples of screens each of which is displayed in the client terminal in the preprocessing.

FIG. 8 is a diagram illustrating an example of a sequence which is executed when the client terminal connects to the image processing apparatus to perform scanning.

FIGS. 9A, 9B, and 9C are diagrams illustrating examples of screens each of which is displayed in the client terminal before the completion of scan preparation.

FIGS. 10A, 10B, and 10C are diagrams illustrating examples of screens each of which is displayed in the client terminal after the completion of scan preparation.

FIGS. 11A and 11B are diagrams illustrating examples of screens each of which is displayed in the image processing apparatus.

FIG. 12 is a flowchart illustrating an example of processing which the client terminal performs in the first exemplary embodiment.

FIGS. 13A and 13B are diagrams illustrating examples of error screens each of which is displayed in the client terminal.

FIGS. 14A and 14B are flowcharts illustrating an example of processing which the image processing apparatus performs in the first exemplary embodiment.

FIGS. 15A, 15B, and 15C are diagrams illustrating examples of error screens each of which is displayed in the image processing apparatus.

FIG. 16 is a flowchart illustrating an example of processing which the image processing apparatus performs in a second exemplary embodiment.

FIG. 17 is a diagram illustrating an example of a favorite setting change screen which is displayed in the image processing apparatus in the second exemplary embodiment.

FIG. 18 is a flowchart illustrating an example of processing which the client terminal performs in the second exemplary embodiment.

FIG. 19 is a diagram illustrating an example of a list of favorite setting files which are currently registered with the client terminal in the second exemplary embodiment.

FIG. 20 is a flowchart illustrating an example of processing which the image processing apparatus performs in the second exemplary embodiment.

### DESCRIPTION OF THE EMBODIMENTS

Various exemplary embodiments, features, and aspects of the disclosure will be described in detail below with reference to the drawings. However, not all of the features described in the following exemplary embodiments are necessarily essential for solutions in the present disclosure. The following exemplary embodiments are described with respect to an example in which an image processing apparatus and a client terminal cooperate with each other.

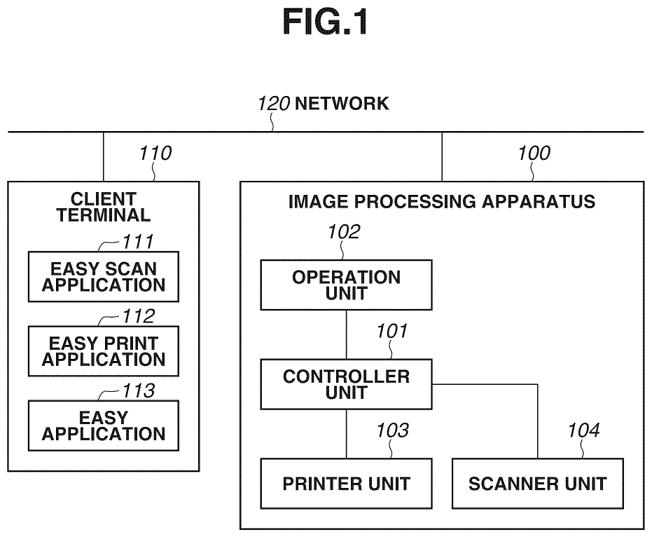

FIG. 1 is a diagram illustrating an example of a system according to a first exemplary embodiment of the present disclosure.

The system in the first exemplary embodiment includes an image processing apparatus 100 and a client terminal 110. The image processing apparatus 100 and the client terminal 110 are connected via a network 120 in such a way as to be able to communicate with each other. In the first exemplary embodiment, the network 120 is a wireless connection.

The image processing apparatus 100 is, for example, a multifunction peripheral (MFP). The image processing apparatus 100 has the functions of scanning an image to be read, printing an image with a printer, and performing transmission and reception of facsimile (FAX). The image processing apparatus 100 includes an operation unit 102 which takes charge of inputting from and outputting to the user. The image processing apparatus 100 includes a printer unit 103 which outputs electronic data to a paper medium. The image processing apparatus 100 includes a scanner unit 104 which converts an image of a paper medium into electronic data. The operation unit 102, the printer unit 103, and the scanner unit 104 are connected to a controller unit 101, and implement the function as a multifunction peripheral under the control of the controller unit 101. Furthermore, the image processing apparatus 100 does not need to include the printer unit 103.

The client terminal 110 is an information processing apparatus configured to include, for example, application programs (hereinafter referred to as “applications”), such as an easy scan application 111, an easy print application 112, and an easy application 113, an operating system (hereinafter referred to as an “OS”) (not illustrated), and various types of drivers. Moreover, the client terminal 110 can be configured to include various applications such as a document creation application and a spread sheet application (not illustrated).

The easy scan application 111 is an application which performs connection to the image processing apparatus 100 and which launches a file server included in the easy scan application 111 and receives, via the file server, electronic data obtained by the image processing apparatus 100 performing scanning.

Examples of the client terminal 110 include a notebook personal computer (PC), a tablet terminal, and a smartphone. Furthermore, while, with reference to FIG. 1, only a configuration usable for describing the first exemplary embodiment is described, the configuration can include elements other than those illustrated in FIG. 1 as long as the first exemplary embodiment is able to be implemented, and, naturally, the connection configuration between the respective constituent elements is not limited to the one illustrated in FIG. 1.

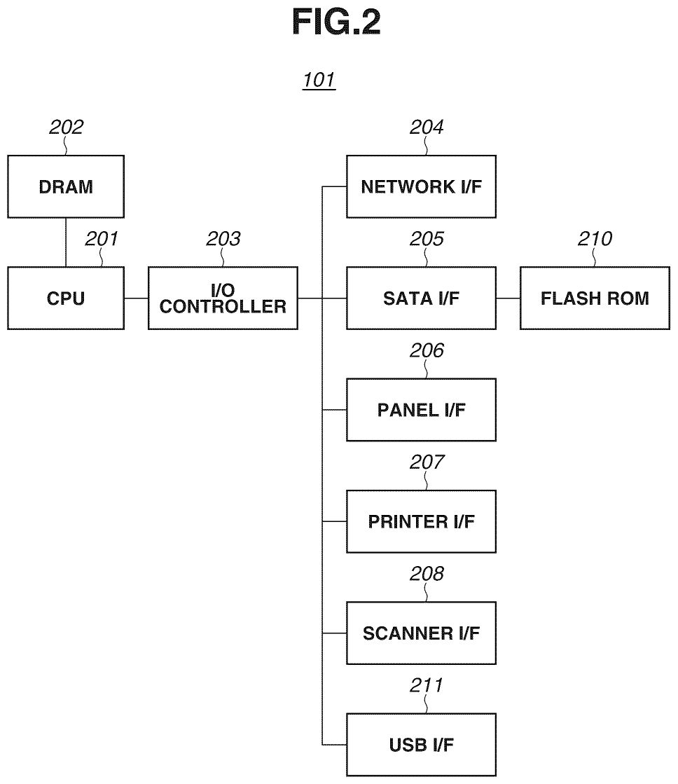

FIG. 2 is a block diagram illustrating an example of particulars of the controller unit 101 of the image processing apparatus 100.

A central processing unit (CPU) 201 performs main arithmetic processing in the controller unit 101. The CPU 201 is connected to a dynamic random access memory (DRAM) 202 via a bus. The DRAM 202 is used by the CPU 201 as a work memory for temporarily allocating program data representing an arithmetic operation command during the process in which the CPU 201 performs arithmetic operation and data which is targeted for processing.

Moreover, the CPU 201 is connected to an input-output (I/O) controller 203 via a bus. The I/O controller 203 performs inputting and outputting to and from various devices under the control of the CPU 201.

To the I/O controller 203, a Serial Advanced Technology Attachment (SATA) interface (I/F) 205 is connected, and, to the SATA I/F 205, a flash read-only memory (ROM) 210 is connected. The CPU 201 uses the flash ROM 210 to permanently store a program for implementing the function of the image processing apparatus 100 and a document file. Not a flash ROM but another type of storage device such as a hard disk drive (HDD) can be connected or these can be used in combination.

Moreover, to the I/O controller 203, a network I/F 204 is also connected. To the network I/F 204, a wired local area network (LAN) device or a wireless LAN device is connected. The CPU 201 controls the wired LAN device or wireless LAN device via the network I/F 204, thus implementing communications on the network 120.

Moreover, to the I/O controller 203, a panel I/F 206 is connected. The CPU 201 implements inputting and outputting for the user to and from the operation unit 102 via the panel I/F 206.

Moreover, to the I/O controller 203, a printer I/F 207 is connected. The CPU 201 implements output processing for a paper medium using the printer unit 103 via the printer I/F 207.

Moreover, to the I/O controller 203, a scanner I/F 208 is connected. The CPU 201 implements reading of an image from an original using the scanner unit 104 via the scanner I/F 208.

Moreover, to the I/O controller 203, a Universal Serial Bus (USB) I/F 211 is connected. The CPU 201 implements access to USB equipment which is connected to the USB I/F 211. For example, the CPU 201 implements writing and reading processing of data to and from a storage medium such as a USB memory which is connected to the USB I/F 211.

The image processing apparatus 100 is configured to include various applications for using the functions of the image processing apparatus 100. Examples of the applications include applications corresponding to a copy function, a transmission function, a facsimile function, and a box function. The CPU 201 implements these functions by reading program data corresponding to each of the respective functions from the flash ROM 210 via the SATA I/F 205 onto the DRAM 202 and executing the program data.

In the case of executing the copy function, the CPU 201 detects a copy instruction from the user with respect to the operation unit 102 via the panel I/F 206, according to a program read onto the DRAM 202. Upon detecting the copy instruction, the CPU 201 receives an image of an original as electronic data from the scanner unit 104 via the scanner I/F 208, and then stores the electronic data in the DRAM 202. The CPU 201 performs, for example, color conversion processing adapted for outputting on image data stored in the DRAM 202. The CPU 201 transfers image data stored in the DRAM 202 to the printer unit 103 via the printer I/F 207, thus performing output processing to a paper medium.

Processing which the CPU 201 performs to detect a transmission instruction from the user in the case of executing the transmission function is the same as that in the case of executing the copy function. The transmission instruction includes, for example, a transmission protocol from the user, a transmission destination designation, and an image format. The transmission protocol is, for example, Server Message Block (SMB) or File Transfer Protocol (FTP), and the transmission destination designation is, for example, a designation using Universal Naming Convention (UNC). The image format is, for example, Joint Photographic Experts Group (JPEG) or Portable Document Format (PDF). Upon detecting the transmission instruction, the CPU 201 receives an image of an original as electronic data from the scanner unit 104 via the scanner I/F 208, and then stores the electronic data in the DRAM 202. The CPU 201 performs, for example, image format conversion designated by the user on image data stored in the DRAM 202. The CPU 201 performs transfer of image data stored in the DRAM 202 to a transmission destination with a protocol designated by the user via the network I/F 204. In response to a storage server (not illustrated) being designated as a transmission destination, the CPU 201 can perform transfer with use of a method of approval using an access token.

Processing which the CPU 201 performs to detect a facsimile instruction from the user in the case of executing the facsimile function is the same as that in the case of executing the copy function. Upon detecting the facsimile instruction, the CPU 201 receives an image of an original as electronic data from the scanner unit 104 via the scanner I/F 208, and then stores the electronic data in the DRAM 202. The CPU 201 performs, for example, image format conversion for facsimile on image data stored in the DRAM 202. The CPU 201 performs transfer of image data stored in the DRAM 202 to, for example, a facsimile telephone number designated by the facsimile instruction, via, for example, a telephone network (not illustrated) to which a facsimile I/F (not illustrated) is connected. Facsimile using a telephone line is merely an example, and Internet facsimile can also be used.

The box function is a function of storing a scanned image in a storage region inside the image processing apparatus 100 or in a memory medium connected to the image processing apparatus 100 or, with the image processing apparatus 100 serving as a file server, releasing an image stored in the image processing apparatus 100 to an external PC or another image processing apparatus (each not illustrated). Processing which the CPU 201 performs to detect a box storage instruction from the user in the case of executing the box function is the same as that in the case of executing the copy function. The box storage instruction includes, for example, a storage destination designation from the user and an image format. The storage destination is a path of a storage inside the image processing apparatus 100 or a memory medium connected to the image processing apparatus 100. The image format is, for example, JPEG or PDF. Upon detecting the box storage instruction, the CPU 201 receives an image of an original as electronic data from the scanner unit 104 via the scanner I/F 208, and then stores the electronic data in the DRAM 202. The CPU 201 performs, for example, image format conversion designated by the user on image data stored in the DRAM 202. The CPU 201 performs transfer of image data stored in the DRAM 202 to a storage destination designated by the user, such as the flash ROM 210 inside the image processing apparatus 100 or a memory medium (not illustrated), via the SATA I/F 205.

Furthermore, the facsimile function can also include not printing a received image but converting the received image into a format available for viewing by, for example, a PC and storing the converted image into a box. Moreover, the box function can include, with the image processing apparatus 100 serving as a file server such as an SMB server, releasing the content of the flash ROM 210. In the box function, the CPU 201 detects a box access instruction received from an external unit via the network I/F 204. The box access instruction includes, for example, an image file path of the access destination. The CPU 201 performs transfer of image data stored in the flash ROM 210 corresponding to the designated image file path to a request source (requester) of the box access instruction via the network I/F 204.

Furthermore, the above-described functions are merely examples of functions of the image processing apparatus 100 and can additionally include functions other than the above-described functions.

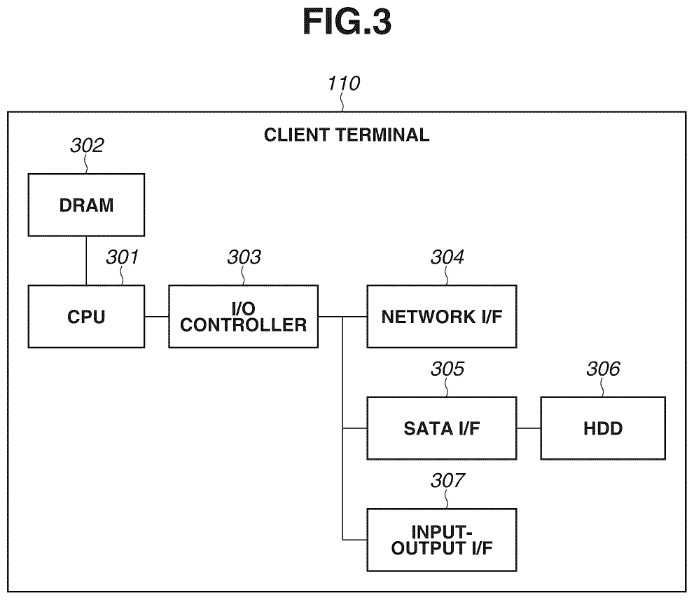

FIG. 3 is a block diagram illustrating an example of particulars of the client terminal 110.

A CPU 301 is connected to a DRAM 302 via a bus. The DRAM 302 is used by the CPU 301 as a work memory for temporarily allocating program data representing an arithmetic operation command during the process in which the CPU 301 performs arithmetic operation and data which is targeted for processing.

The CPU 301 is connected to an I/O controller 303 via a bus.

To the I/O controller 303, a network I/F 304 is connected. To the network I/F 304, a wired LAN device or a wireless LAN device, or a data communication device, is connected. The CPU 301 controls the wired LAN device, the wireless LAN device, or the data communication device via the network I/F 304, thus implementing communications on the network 120.

Moreover, the I/O controller 303 performs inputting and outputting to and from various devices under the control of the CPU 301.

To the I/O controller 303, a Serial Advanced Technology Attachment (SATA) I/F 305 is connected, and, to the SATA I/F 305, an HDD 306 is connected. Not an HDD but another type of storage device such as a solid state drive (SSD) or an embedded MultiMediaCard (eMMC) can be connected or these can be used in combination. The CPU 301 uses the HDD 306 to permanently store setting values for, for example, programs such as the easy scan application 111, the easy print application 112, and the easy application 113.

Moreover, to the I/O controller 303, an input-output I/F 307 is connected, and the CPU 301 implements inputting and outputting for the user to and from an input-output device of the client terminal 110 connected via the input-output I/F 307. Examples of the input-output device include a touch panel serving as both input and output units being connected to the input-output I/F 307 and a set including an output device such as a display for performing displaying and an input device such as a keyboard for performing inputting, each of the output device and the input device being connected to the input-output I/F 307. Moreover, a storage medium such as a USB memory being mounted to the input-output I/F 307 enables performing writing and reading processing of data to and from the storage medium. Moreover, a USB cable being connected to the input-output I/F 307 to connect the client terminal 110 to the image processing apparatus 100 via the USB cable also enables performing communication with the image processing apparatus 100.

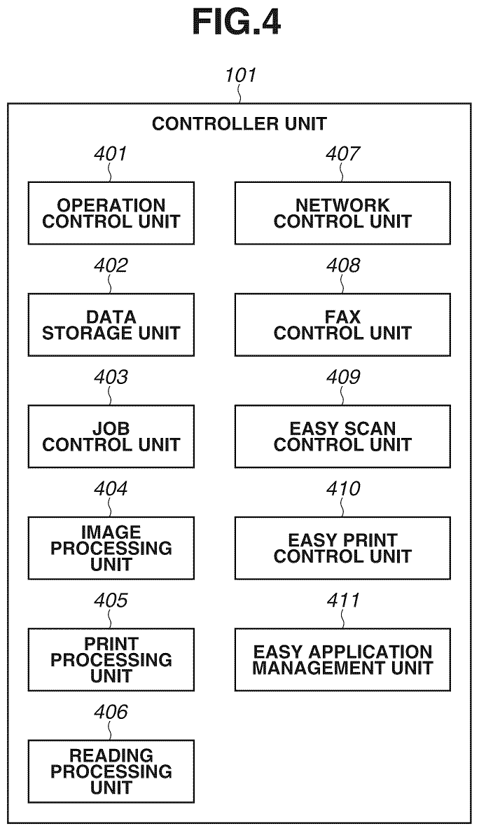

FIG. 4 is a block diagram illustrating an example of a configuration of software which is executed by the controller unit 101 of the image processing apparatus 100. The software which is executed by the controller unit 101 is executed after the CPU 201 reads out a program stored in the flash ROM 210 onto the DRAM 202, and thus implements functional units such as units 401 to 411 illustrated in FIG. 4.

An operation control unit 401 performs processing for displaying a screen image directed to the user on the operation unit 102 and processing associated with detection of a user operation performed via the operation unit 102 and screen components such as buttons displayed in the screen.

A data storage unit 402 performs storing and reading-out of a request from another control unit in and from the flash ROM 210.

A job control unit 403 controls execution of a job according to an instruction from another control unit.

An image processing unit 404 processes image data into a form adapted for each use application according to an instruction from the job control unit 403.

A print processing unit 405 prints and outputs an image on a paper medium via the printer I/F 207 according to an instruction from the job control unit 403.

A reading processing unit 406 scans a set original via the scanner I/F 208 according to an instruction from the job control unit 403.

A network control unit 407 performs inputting and outputting of data to and from a LAN, Wi-Fi®, or a public line network via the network I/F 204 according to an instruction from each control unit. Moreover, the network control unit 407 makes data stored in the flash ROM 210 by the data storage unit 402 via the SATA I/F 205 accessible from an external device. Examples of data to be stored in the flash ROM 210 include an image of, for example, PDF or JPEG format.

A facsimile (FAX) control unit 408 performs reception processing on FAX data received from the network control unit 407 according to an instruction from the job control unit 403, and instructs the print processing unit 405 to perform printing or converts FAX data into an image of, for example, PDF or JPEG format and stores the obtained image in the data storage unit 402. Moreover, the FAX control unit 408 performs transmission of FAX data via the network control unit 407 based on image data obtained by scanning performed by the reading processing unit 406.

An easy scan control unit 409 performs processing concerning scanning with the client terminal 110. The easy scan control unit 409 is a control unit for implementing the processing to be performed on the side of the image processing apparatus 100 to implement the function of the easy scan application 111 described above with reference to FIG. 1. The easy scan control unit 409 uses the network control unit 407 to perform communication processing with the client terminal 110. Moreover, the easy scan control unit 409 uses the operation control unit 401 to perform displaying of a scan execution screen or an error screen. Moreover, the easy scan control unit 409 issues a scan instruction to the job control unit 403, performs scanning with use of the reading processing unit 406, and transmits scan data stored in the data storage unit 402 to the client terminal 110 with use of the network control unit 407.

An easy print control unit 410 performs processing concerning printing with the client terminal 110. The easy print control unit 410 is a control unit for implementing the processing to be performed on the side of the image processing apparatus 100 to implement the function of the easy print application 112 described above with reference to FIG. 1. The easy print control unit 410 uses the network control unit 407 to perform communication processing with the client terminal 110. Moreover, the easy print control unit 410 uses the operation control unit 401 to display a print execution screen or an error screen and issue a print instruction to the job control unit 403, thus performing printing of print data transmitted from the client terminal 110 and then stored in the data storage unit 402 with use of the print processing unit 405. Furthermore, in the description of the first exemplary embodiment, an example in which, without immediately printing print data received from the client terminal 110, the image processing apparatus 100 temporarily stores the print data in the data storage unit 402 and then performs printing of the print data in response to the user issuing a print instruction via a print execution screen which is displayed on the operation unit 102 by the easy print control unit 410 is described. This is because of preventing a printed sheet from being left unattended in the image processing apparatus 100.

An easy application management unit 411 performs processing which is performed at the time of connection to and at the time of disconnection from the easy application 113 included in the client terminal 110. When being connected from the easy application 113 of the client terminal 110 via the network control unit 407, the easy application management unit 411 requests the easy scan control unit 409 or the easy print control unit 410 to control scanning or printing. Moreover, the easy application management unit 411 instructs the operation control unit 401 to perform display processing or deletion processing of a button for executing easy print or easy scan in a menu screen of the image processing apparatus 100, as described below. When a disconnection instruction has been received from the easy application 113 of the client terminal 110 or when the image processing apparatus 100 itself performs disconnection, the easy application management unit 411 performs processing for disconnection from the client terminal 110 with use of the network control unit 407.

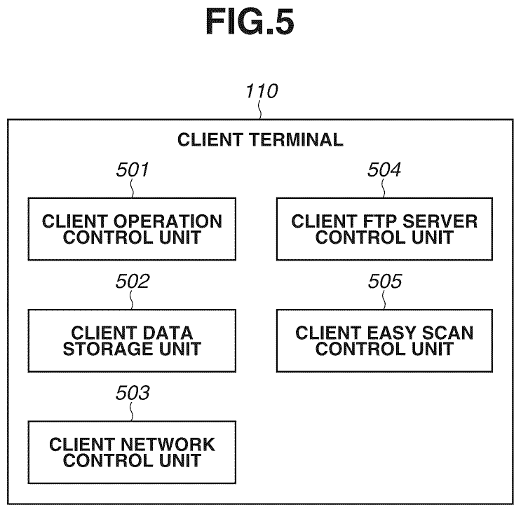

FIG. 5 is a block diagram illustrating an example of a software configuration of the client terminal 110.

Software including the easy scan application 111 which is executed by the client terminal 110 is executed after the CPU 301 reads out a program stored in the HDD 306 onto the DRAM 302, and thus implements functional units such as units 501 to 505 illustrated in FIG. 5.

A client operation control unit 501 performs processing for displaying a screen image directed to the user and processing associated with detection of a user operation and screen components such as buttons displayed in the screen.

A client data storage unit 502 performs storing and reading-out of electronic data such as an image file in and from the HDD 306.

A client network control unit 503 performs network communication with an external apparatus.

A client FTP server control unit 504 executes an FTP server function inside the client terminal 110 and performs exchange of data with the image processing apparatus 100 with use of the client network control unit 503.

A client easy scan control unit 505 uses the above-mentioned units 501 to 504 to provide an easy scan function (the function of the easy scan application 111) to the user of the client terminal 110.

Furthermore, while the client terminal 110 operates according to an OS and, on the OS, applications such as the easy scan application 111 run, since the OS is not the gist of the first exemplary embodiment, operations of the OS are omitted from description.

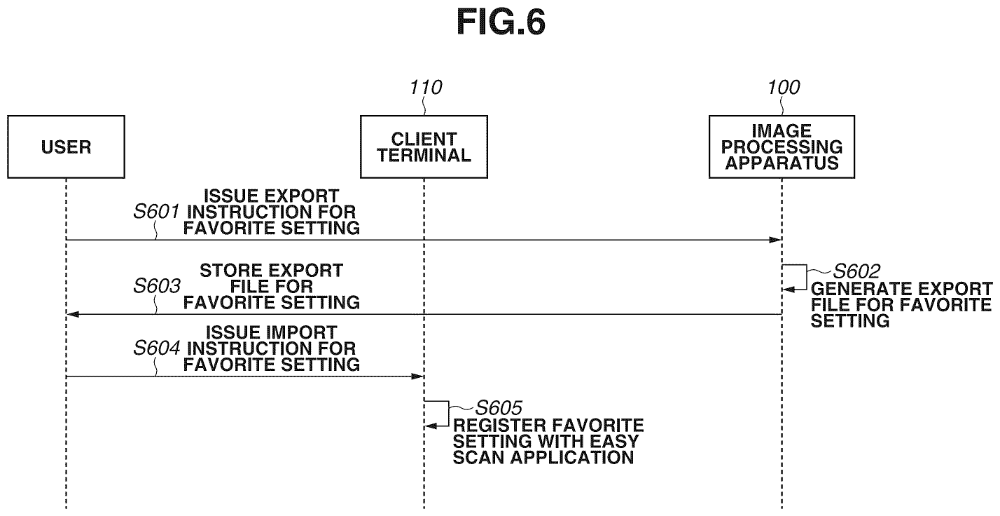

Next, the outline of an operation of the system in the first exemplary embodiment is described with reference to FIG. 6 to FIGS. 15A, 15B, and 15C.

### <Sequence of Preprocessing>

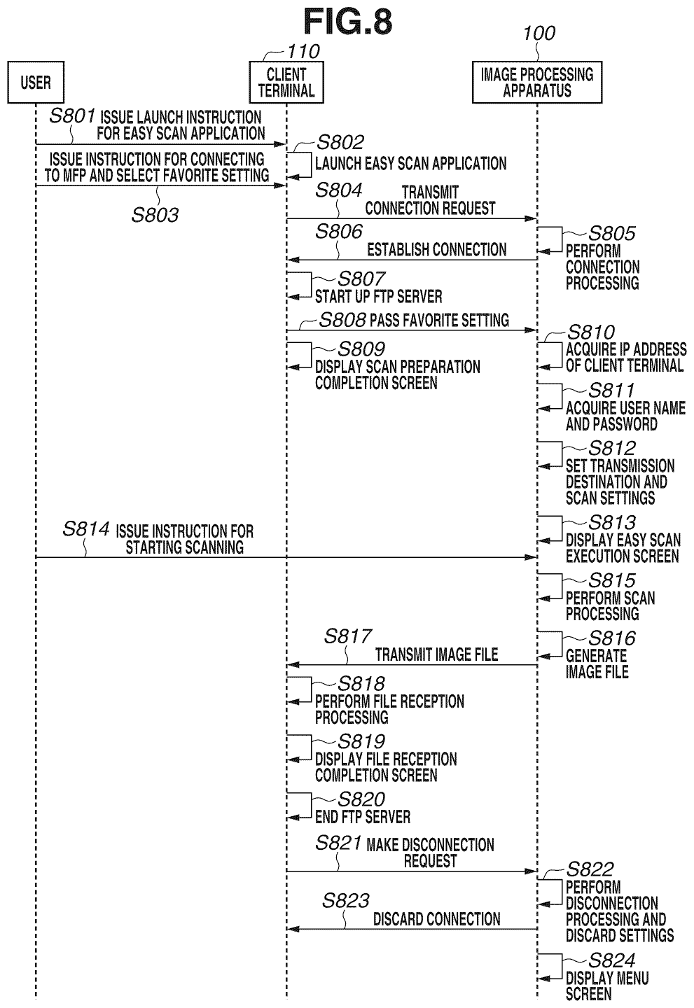

FIG. 6 is a diagram illustrating an example of a sequence representing preprocessing which is performed in the first exemplary embodiment. Furthermore, processing illustrated in each of the sequence diagrams of FIG. 6 and FIG. 8 described below which is performed in the client terminal 110 is performed by a function implemented by the CPU 301 reading out a program stored in the HDD 306 onto the DRAM 302 and executing the program. Moreover, processing illustrated in each of the sequence diagrams of FIG. 6 and FIG. 8 described below which is performed in the image processing apparatus 100 is performed by a function implemented by the CPU 201 reading out a program stored in the flash ROM 210 onto the DRAM 202 and executing the program.

While, in the first exemplary embodiment, scan settings at the time of execution of scanning are designated from the client terminal 110, preprocessing for preliminarily generating scan settings is required. Here, scan settings at the time of execution of scanning are assumed to be collectively referred to as a “favorite setting”, and the easy scan application 111 is assumed to be previously installed on the client terminal 110. In the following sequence, an operation which is performed in the case of the occurrence of an error is not related to the gist of the first exemplary embodiment and is, therefore, omitted from description.

In step S601, the user operates the operation unit 102 to issue an export instruction for a favorite setting file used at the time of desired scanning to the image processing apparatus 100. In step S602, upon receiving the export instruction for favorite setting, the image processing apparatus 100 generates an export file for favorite setting corresponding to the received export instruction. The export file to be generated at this time can be a file of the comma separated value (CSV) format, and can be a file of any format as long as it is a file which the easy scan application 111 is able to process. Moreover, export processing of setting values is a known technique and, therefore, the detailed description thereof is omitted.

In step S603, the image processing apparatus 100 stores the export file generated in step S602 in a storage medium such as a USB memory, and the user acquires the storage medium storing the export file.

Next, in step S604, the user mounts the storage medium, in which the export file has been stored in step S603, to the client terminal 110, and operates the input device of the client terminal 110 to issue an import instruction for favorite setting to the easy scan application 111.

Furthermore, the image processing apparatus 100 can be configured to directly pass the export file to the easy scan application 111 of the client terminal 110 without via a storage medium such as a USB memory. In this case, the client terminal 110 and the image processing apparatus 100 can be interconnected by a network such as Wi-Fi or can be interconnected by, for example, a USB cable.

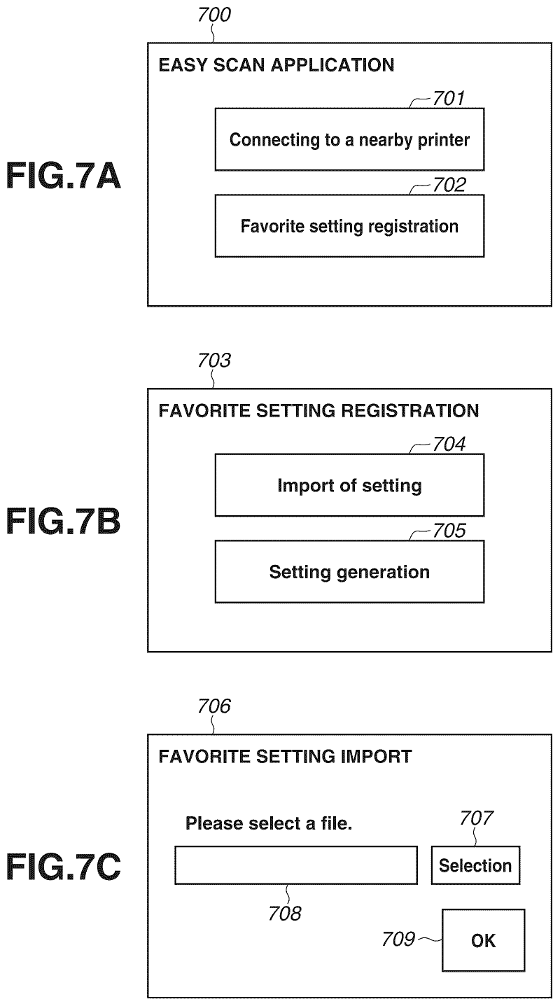

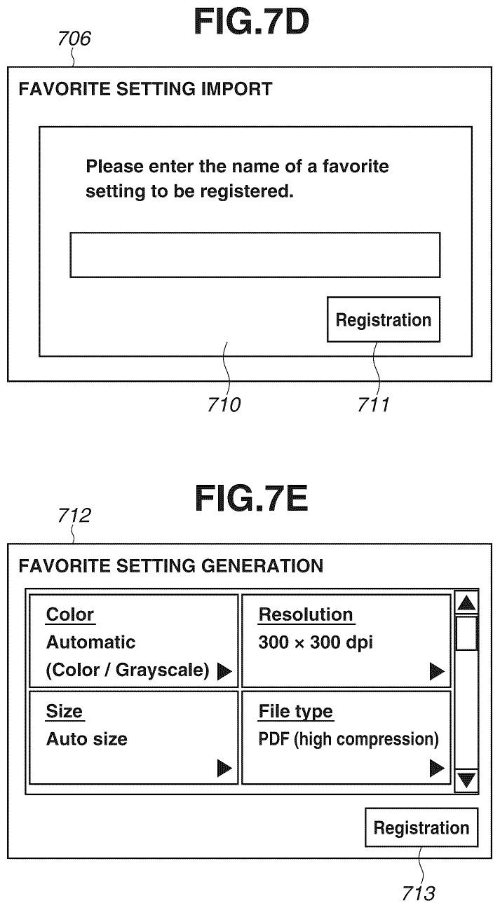

In step S605, the easy scan application 111 of the client terminal 110, which has received the import instruction for favorite setting, imports a setting file for the designated favorite setting (the above-mentioned export file generated in step S602) and then registers the imported setting file as a favorite setting with the easy scan application 111 itself. The above-mentioned steps S604 and S605 are further described with reference to FIGS. 7A, 7B, 7C, 7D, and 7E.

FIGS. 7A to 7E are diagrams illustrating examples of screens each of which is displayed when the easy scan application 111 of the client terminal 110 registers the favorite setting.

In response to the user launching the easy scan application 111 of the client terminal 110, an easy scan application screen 700 such as that illustrated in FIG. 7A is displayed on the output device of the client terminal 110. As illustrated in FIG. 7A, in the easy scan application screen 700, a connection instruction button 701 for “connecting to a nearby printer” and a favorite setting registration button 702 are displayed. The connection instruction button 701 for “connecting to a nearby printer” is described below and is, therefore, omitted from description here.

In response to the user pressing the favorite setting registration button 702 to perform favorite setting registration, the easy scan application 111 displays a favorite setting registration screen 703 such as that illustrated in FIG. 7B on the output device. In the favorite setting registration screen 703, a button 704 for “import of setting” and a setting generation button 705 are displayed.

Next, in response to the user pressing the button 704 for “import of setting”, the easy scan application 111 displays a favorite setting import screen 706 such as that illustrated in FIG. 7C on the output device.

The user presses a selection button 707 in the favorite setting import screen 706, and selects, for example, the export file, in which the favorite setting acquired in the above-mentioned step S603 has been exported, stored in a storage medium such as a USB memory mounted to the client terminal 110.

In response to the favorite setting file being selected, the easy scan application 111 displays a path of the selected favorite setting file in a field 708. Here, in response to the user pressing an OK button 709, the easy scan application 111 displays a dialog box (a name registration screen 710) such as that illustrated in FIG. 7D on the output device.

In response to the user entering a name of the favorite setting and pressing a registration button 711 in the name registration screen 710, the easy scan application 111 stores and manages, in the HDD 306, the favorite setting file selected in the favorite setting import screen 706 with the name entered in the name registration screen 710 as one of favorite settings.

Furthermore, the conceivable method for favorite setting registration can include the easy scan application 111 generating a favorite setting. This is enabled by the user pressing the setting generation button 705 in the favorite setting registration screen 703.

In response to the user pressing the setting generation button 705, the easy scan application 111 displays a favorite setting generation screen 712 such as that illustrated in FIG. 7E on the output device. The user selects the respective scan settings such as resolution and size in the favorite setting generation screen 712 and then presses a registration button 713. In response to the registration button 713 being pressed, as with that in the case of import of scan settings, the easy scan application 111 displays the name registration screen 710 and stores the favorite setting in the similar procedure.

### <Connection and Scan Execution Sequence>

FIG. 8 is a diagram illustrating an example of a sequence which is executed when the client terminal 110 connects to the image processing apparatus 100 to perform scanning. Here, only a sequence in which a favorite setting is designated by the easy scan application 111 is described, and a case where a favorite setting is not designated is omitted from description.

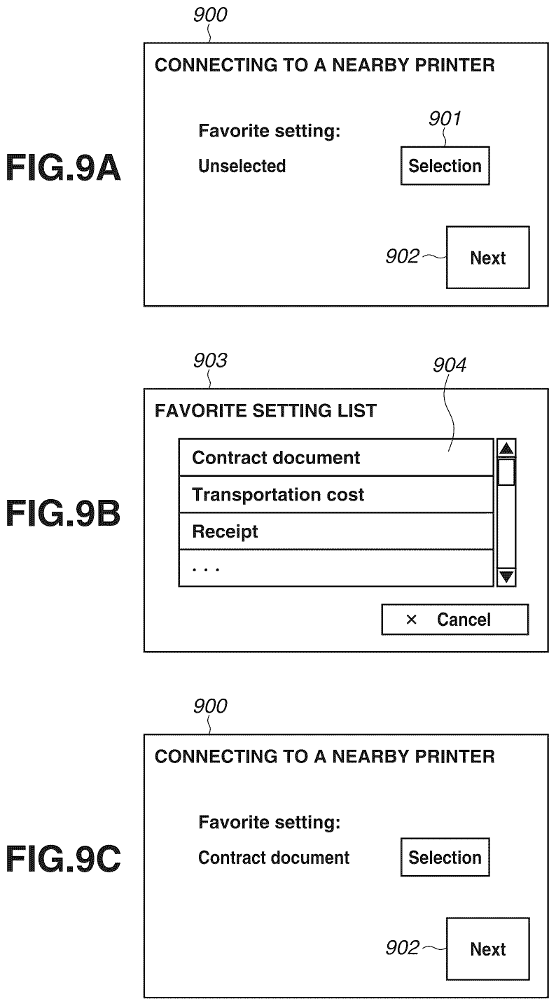

FIGS. 9A, 9B, and 9C are diagrams illustrating examples of screens each of which is displayed in the client terminal 110 before the completion of scan preparation in the first exemplary embodiment.

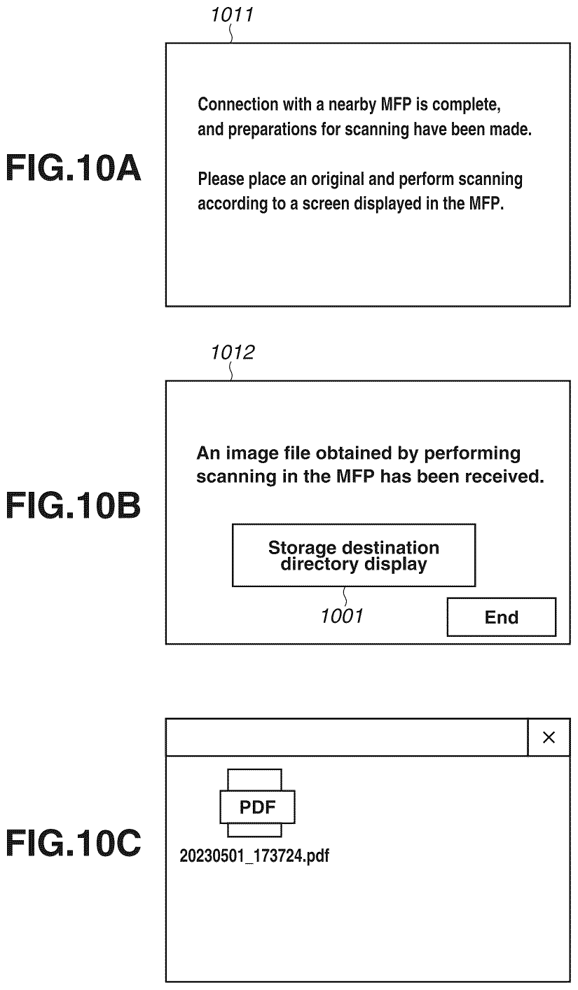

FIGS. 10A, 10B, and 10C are diagrams illustrating examples of screens each of which is displayed in the client terminal 110 after the completion of scan preparation in the first exemplary embodiment.

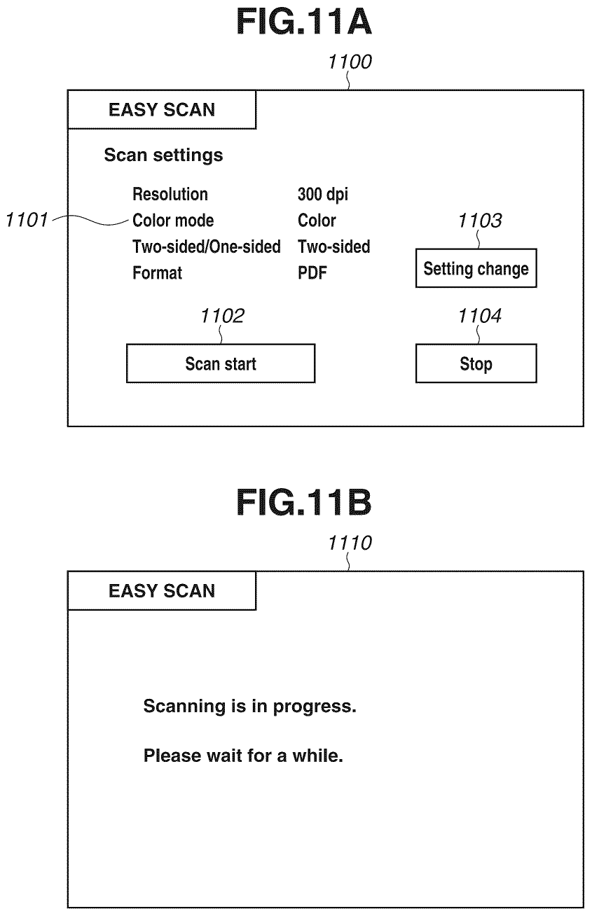

FIGS. 11A and 11B are diagrams illustrating examples of screens each of which is displayed in the image processing apparatus 100 in the first exemplary embodiment.

In step S801, the user operates the input device of the client terminal 110 to issue a launch instruction for the easy scan application 111 to the client terminal 110. In step S802, the client terminal 110, which has received the launch instruction, launches the easy scan application 111. At this time, in the easy scan application 111, the easy scan application screen 700 such as that illustrated in FIG. 7A is displayed.

In the easy scan application screen 700, the connection instruction button 701 for connecting to the image processing apparatus 100 near the easy scan application 111 is displayed. In step S803, the user presses the connection instruction button 701 to cause the client terminal 110 to connect to the nearby image processing apparatus 100, and then selects a favorite setting to be used.

First, in response to the connection instruction button 701 being pressed, the easy scan application 111 displays, on the output device, a screen 900 for “connecting to a nearby printer”, such as that illustrated in FIG. 9A. In this state, with regard to the screen 900 for “connecting to a nearby printer”, at first, the favorite setting is set unselected, and, in response to the user selecting a selection button 901, the favorite setting becomes selectable. Furthermore, in a case where a plurality of nearby MFPs exists, first, the easy scan application 111 can cause the user to select an MFP serving as a connection destination from a list of nearby MFPs and then display the screen 900 for “connecting to a nearby printer”.

In response to the user pressing the selection button 901, the easy scan application 111 displays, on the output device, a favorite setting list screen 903 such as that illustrated in FIG. 9B. The user is allowed to select a favorite setting which the user wants to use, from a list of favorite settings. Here, it is assumed that the user has selected a favorite setting named as contract document 904 and has pressed a portion corresponding to the contract document 904. Upon receiving such a user's selection, the easy scan application 111 reflects the selection in displaying of a favorite setting in the screen 900 for “connecting to a nearby printer”, as illustrated in FIG. 9C.

Next, the user presses a next button 902 to issue a connection instruction, and the easy scan application 111 advances to connection processing. Upon receiving the connection instruction from the user, in step S804, the easy scan application 111 causes the client terminal 110 to transmit, to the image processing apparatus 100, a connection request for connection to the nearby image processing apparatus 100.

Upon receiving the connection request from the client terminal 110, in step S805, the image processing apparatus 100 performs connection processing. Thus, in step S806, a connection for network communication is established between the image processing apparatus 100 and the client terminal 110. The connection for network communication between the image processing apparatus 100 and the client terminal 110 performed in the above-mentioned step S804 to step S806 is performed by, for example, known Wi-Fi Direct. Furthermore, this connection can be implemented not only by Wi-Fi Direct but also by another wireless communication such as Bluetooth®, and can be configured to be a connection using a wired LAN.

After the establishment of a connection for network communication, in step S807, the client terminal 110 performs start-up of an FTP server. Furthermore, while, in the first exemplary embodiment, an example in which FTP is used as a file transfer protocol for scanned electronic data between the image processing apparatus 100 and the client terminal 110 is described, the file transfer protocol is not limited to FTP as long as it is a protocol capable of transmitting a file. For example, SSH File Transfer Protocol or Secure File Transfer Protocol (SFTP), Server Message Block (SMB), Web-based Distributed Authoring and Versioning (WebDAV), or HyperText Transfer Protocol (HTTP) can be employed. Thus, in step S807, the client terminal 110 enables a function for receiving scan data from the image processing apparatus 100, according to a communication connection with the image processing apparatus 100.

After the completion of start-up of the FTP server, in step S808, the client terminal 110 passes the selected favorite setting from the FTP server to the image processing apparatus 100. At this time, the method of passing a favorite setting can be a method of passing a favorite setting file of, for example, the comma separated value (CSV) format or can be a method of, for example, designating a favorite setting as the respective setting values on the premise that a communication is established with a protocol other than FTP.

Furthermore, in the above-mentioned step S803 to step S808, after the MFP connection instruction and the favorite setting selection performed by the user, the client terminal 110 establishes a communication connection with the image processing apparatus 100 and transmits the favorite setting to the image processing apparatus 100. However, a configuration in which the client terminal 110 establishes a communication connection with the image processing apparatus 100 in response to the MFP connection instruction and accepts a selection input for a favorite setting performed by the user in response to the establishment of the communication connection can be employed.

Moreover, in step S809, the easy scan application 111 displays a scan preparation completion screen 1011 such as that illustrated in FIG. 10A on the output device.

After the establishment of the connection for network communication in the above-mentioned step S806, in step S810, the image processing apparatus 100 acquires an Internet Protocol (IP) address of the client terminal 110. Here, the image processing apparatus 100 acquires, for example, an IP address which has been set when connection has been performed with Wi-Fi Direct.

Moreover, in step S811, the image processing apparatus 100 acquires a user name and a password which are used in FTP for transmitting scanned electronic data. The user name and password can be preliminarily fixedly determined ones between the image processing apparatus 100 and the client terminal 110. Alternatively, the user name and password can be unique values generated with use of hash functions in common between the image processing apparatus 100 and the client terminal 110 from, for example, the allocated IP address and date and time. Moreover, a configuration in which, for example, the IP address of the client terminal 110 and the above-mentioned user name and password are transmitted from the client terminal 110 to the image processing apparatus 100 and, then, the image processing apparatus 100 receives these can be employed.

Additionally, in step S812, the image processing apparatus 100 sets, as a transmission destination of scanned electronic data, the IP address acquired in the above-mentioned step S810 and the user name and password acquired in the above-mentioned step S811. Moreover, the image processing apparatus 100 reflects the favorite setting acquired in the above-mentioned step S808 in the scan settings.

After a processing operation in the above-mentioned step S812, since the image processing apparatus 100 has become ready for performing scanning, in step S813, the image processing apparatus 100 displays an easy scan execution screen 1100 such as that illustrated in FIG. 11A on the operation unit 102. In this instance, the image processing apparatus 100 displays scan settings 1101 for the favorite setting passed in the above-mentioned step S808 in the easy scan execution screen 1100.

The example of the scan settings illustrated in FIG. 11A is an example in which the scan resolution is set to 300 dots per inch (dpi), the color setting is set to color, scanning is set to two-sided scanning, and the file format is set to PDF. The scan settings can be not only the ones 1101 but also other settings. While, in the first exemplary embodiment, an example in which an automatic document feeder (ADF) is used is described, naturally, a configuration in which scanning is performed with an original being placed on a platen glass can be employed.

A setting change button 1103 is a button operable to change scan settings. A scan start button 1102 is a button operable to perform scanning. A stop button 1104 is a button which is pressed to stop easy scan. Specifically, the stop button 1104 is a button which is used to stop easy scan in a case where, for example, when a given user has performed connection to the image processing apparatus 100 but, without using the image processing apparatus 100, has left the image processing apparatus 100 unattended while maintaining connection, another user wants to use the image processing apparatus 100 for, for example, copying.

In step S814, the user sets an original in the image processing apparatus 100 and then presses the scan start button 1102 in the easy scan execution screen 1100 such as that illustrated in FIG. 11A, thus issuing an instruction for starting scanning.

Upon receiving the instruction for starting scanning, in step S815, the image processing apparatus 100 scans the original via the ADF according to the settings for scanning included in the scan settings 1101, thus performing scan processing. In the case of the example illustrated in FIG. 11A, scanning is performed with settings of resolution 300 dpi, color, and two-sided scanning. During the process of scanning, the image processing apparatus 100 displays a screen 1110 indicating scan in progress such as that illustrated in FIG. 11B on the operation unit 102.

In step S816, after completing scanning of the original, the image processing apparatus 100 generates an image file according to the file format defined in the scan settings 1101. In the case of the example illustrated in FIG. 11A, the image processing apparatus 100 generates a PDF file. The file name can be a unique name created based on the date and time at which scanning has been performed or can be a name acquired from a result of optical character recognition (OCR).

Next, in step S817, the image processing apparatus 100 connects to the client terminal 110 by FTP with the IP address, user name, and password set in the above-mentioned step S812, and then transmits the file generated in the above-mentioned step S816 to the client terminal 110. At this time, instead of transmitting the scanned file to a top directory of the FTP server of the client terminal 110, the image processing apparatus 100 can transmit the scanned file to a directory of, for example, the date at which scanning was performed (or the date at which connection was performed). Furthermore, the authentication or file transmission using a file transfer protocol such as FTP is a known technique and, therefore, the detailed description thereof is omitted.

Moreover, in step S818, the client terminal 110 performs, via the FTP server, reception processing of the file received from the image processing apparatus 100.

After the completion of the reception processing by the FTP server, in step S819, the client terminal 110 displays a file reception completion screen 1012 such as that illustrated in FIG. 10B on the output device.

As illustrated in FIG. 10B, a storage destination directory display button 1001 is provided in the file reception completion screen 1012. In response to the user pressing the storage destination directory display button 1001, the client terminal 110 displays, on the output device, a directory in which the scanned electronic data has been stored, as illustrated in FIG. 10C.

Additionally, in step S820, the client terminal 110 ends the FTP server, which has been started up in the above-mentioned step S807. Thus, in step S820, the client terminal 110 disables a function for receiving scan data from the image processing apparatus 100.

Then, in step S821, the client terminal 110 makes a disconnection request to the image processing apparatus 100.

Upon receiving the disconnection request from the client terminal 110, in step S822, the image processing apparatus 100 performs disconnection processing with Wi-Fi Direct based on the disconnection request, and discards the setting of a transmission destination of the performed scan transmission and the scan settings. In step S823, the above-mentioned disconnection processing discards a connection for network communication between the image processing apparatus 100 and the client terminal 110.

Then, in step S824, the image processing apparatus 100 displays, on the operation unit 102, a menu screen available for copying or facsimile (FAX) (not illustrated), and ends processing for easy scan.

As described above, the user is able to easily perform push scan from the image processing apparatus 100 to the client terminal 110 which the user is using, only by performing a launch instruction for the easy scan application (step S801), an MFP connection instruction and favorite setting selection (step S803), and a scan execution instruction step S814) with an original being set. Then, in response to the completion of scanning, a connection with the image processing apparatus 100 is also automatically severed. This enables preventing the client terminal 110 from remaining connected to the image processing apparatus 100 due to the user forgetting to perform an operation for severing a connection to the image processing apparatus 100.

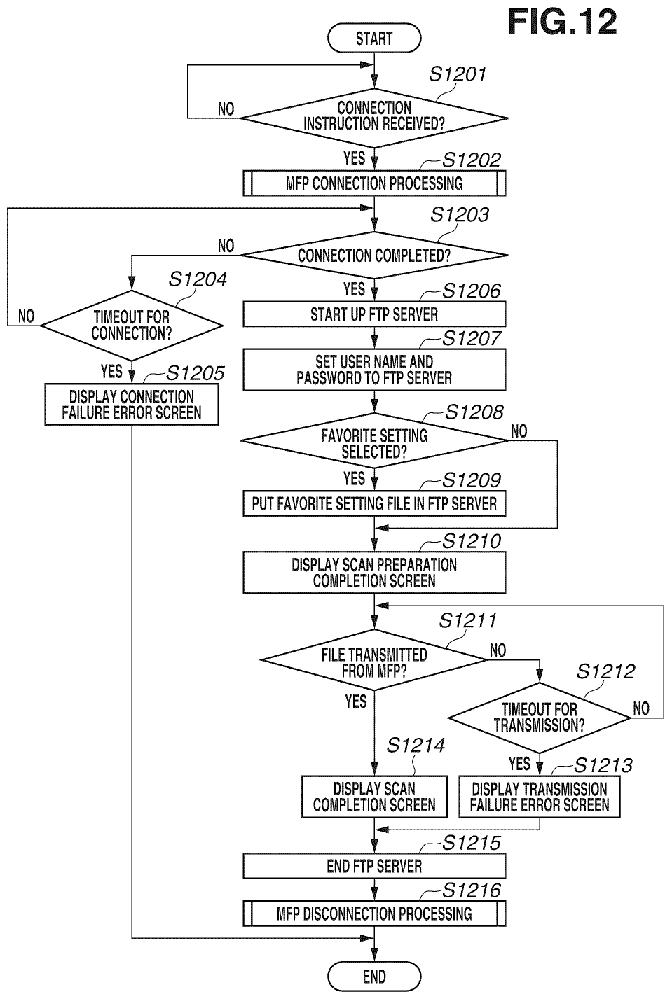

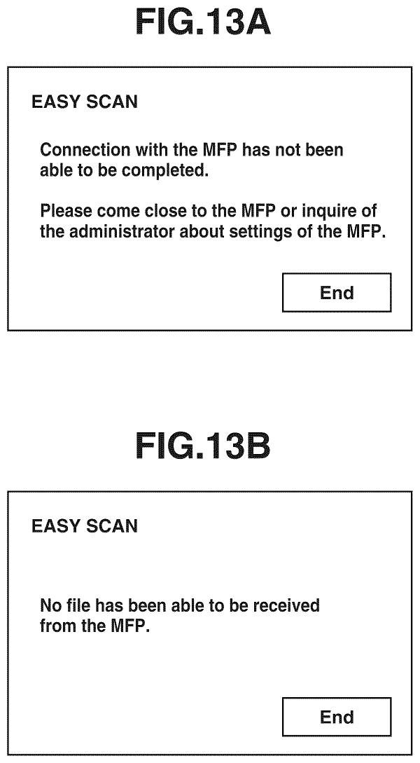

In the following description, processing which the client terminal 110 performs in easy scan is described with reference to FIG. 12 and FIGS. 13A and 13B.

FIG. 12 is a flowchart illustrating an example of processing which the client terminal 110 performs in easy scan (processing in which the easy scan application 111 connects to the image processing apparatus 100 and performs easy scan) in the first exemplary embodiment. The processing illustrated in FIG. 12 is performed by a function which is implemented by the CPU 301 reading out a program stored in the HDD 306 onto the DRAM 302 and executing the program.

FIGS. 13A and 13B are diagrams illustrating examples of error screens each of which is displayed in the client terminal 110 in the first exemplary embodiment.

In the client terminal 110, in response to the user starting an operation to launch the easy scan application 111, the processing illustrated in FIG. 12 is started.

In step S1201, the client easy scan control unit 505 checks whether a connection instruction for connecting to the image processing apparatus 100 has been received. Specifically, the client easy scan control unit 505 determines whether, after the connection instruction button 701 in the easy scan application screen 700 such as that illustrated in FIG. 7A has been pressed, the favorite setting has been selected and the next button 902 has been pressed in the screen 900 for “connecting to a nearby printer” such as that illustrated in FIG. 9A, by checking a response from the client operation control unit 501.

Here, if it is determined that the connection instruction for connecting to the image processing apparatus 100 has not been received (NO in step S1201), the client easy scan control unit 505 repeats the processing operation in step S1201.

On the other hand, if it is determined that the connection instruction for connecting to the image processing apparatus 100 has been received (YES in step S1201), the client easy scan control unit 505 advances the processing to step S1202.

In step S1202, the client easy scan control unit 505 performs, via the client network control unit 503, connection processing for connecting to the image processing apparatus 100. In the connection processing for connecting to the image processing apparatus 100, processing which is performed on the side of the client terminal 110 in step S804 to step S806 illustrated in FIG. 8 is performed to establish a connection between the image processing apparatus 100 and the client terminal 110.

Next, in step S1203, the client easy scan control unit 505 determines whether the connection with the image processing apparatus 100 has been completed. Specifically, the client network control unit 503 checks whether the client terminal 110 has been able to connect to the image processing apparatus 100.

Here, if it is determined that the connection with the image processing apparatus 100 has not been completed (NO in step S1203), the client easy scan control unit 505 advances the processing to step S1204.

In step S1204, the client easy scan control unit 505 determines whether a timeout for connection has occurred. In a case where a predetermined timeout for connection is previously set, if the value of the predetermined timeout is exceeded, the client easy scan control unit 505 determines that a timeout for connection has occurred, and, if the value of the predetermined timeout is not exceeded, the client easy scan control unit 505 determines that a timeout for connection has still not occurred.

Here, if it is determined that a timeout for connection has still not occurred (NO in step S1204), the client easy scan control unit 505 returns the processing to step S1203, in which the client easy scan control unit 505 determines again whether the connection with the image processing apparatus 100 has been completed.

On the other hand, if it is determined that a timeout for connection has occurred (YES in step S1204), the client easy scan control unit 505 advances the processing to step S1205.

In step S1205, the client network control unit 503 uses the client operation control unit 501 to display, on the output device of the client terminal 110, an error screen such as that illustrated in FIG. 13A indicating that the connection with the image processing apparatus 100 has not been completed. FIG. 13A illustrates an example of the error screen. In this case, since the client terminal 110 has not been able to connect to the image processing apparatus 100, after displaying the error screen, the client network control unit 503 ends the processing in the present flowchart.

Moreover, if, in the above-mentioned step S1203, it is determined that the connection with the image processing apparatus 100 has been completed (YES in step S1203), the client network control unit 503 advances the processing to step S1206.

In step S1206, since the connection with the image processing apparatus 100 has been completed, the client network control unit 503 uses the client FTP server control unit 504 to start up the FTP server. This enables the client terminal 110 to communicate with the image processing apparatus 100 using the FTP protocol. Furthermore, while, in the first exemplary embodiment, FTP is used as a file transfer protocol as mentioned above, a configuration in which the client terminal 110 communicates with the image processing apparatus 100 using another protocol can be employed.

Next, in step S1207, the client easy scan control unit 505 sets a user name and a password which are available for accessing the FTP server started up in the above-mentioned step S1206 (a user name and a password which are available for allowing a connection to the FTP server). As mentioned above in step S811 illustrated in FIG. 8, the user name and password can be fixed values or can be unique values generated with use of, for example, hash functions as long as the user name and password are in common between the image processing apparatus 100 and the client terminal 110. Additionally, a configuration in which the user name and password and, for example, the IP address of the client terminal 110 are transmitted from the client terminal 110 to the image processing apparatus 100 can be employed.

In step S1208, the client easy scan control unit 505 determines whether, in the above-mentioned step S1201, the favorite setting has been selected. Specifically, the client easy scan control unit 505 determines whether the screen 900 for “connecting to a nearby printer” is in a state in which the favorite setting is not set unselected, as illustrated in FIG. 9C.

Here, if it is determined that the favorite setting has not been selected (NO in step S1208), the client easy scan control unit 505 advances the processing to step S1210.

On the other hand, if it is determined that the favorite setting has been selected (YES in step S1208), the client easy scan control unit 505 advances the processing to step S1209.

In step S1209, the client easy scan control unit 505 puts a setting file of the favorite setting selected in the above-mentioned step S1201 in the FTP server started up in the above-mentioned step S1206. The directory in which to put the setting file can be a top directory of the FTP server as long as it is a previously determined directory, can be a directory indicating, for example, the date at which the client terminal 110 connected to the image processing apparatus 100, or can be another directory. Furthermore, as mentioned above, in the first exemplary embodiment, the setting file can be a file of the CSV format, or the individual setting values in the setting file can be transmitted by communication using another protocol.

Then, after the processing operation in step S1209, the client easy scan control unit 505 advances the processing to step S1210.

Furthermore, in the above-mentioned step S1201 to step S1209, after the MFP connection instruction and the favorite setting selection by the user, the client terminal 110 establishes a communication connection with the image processing apparatus 100 and transmits the favorite setting to the image processing apparatus 100. However, a configuration in which the client terminal 110 establishes a connection with the image processing apparatus 100 in response to the MFP connection instruction and, in response to the establishment of a communication connection, the client terminal 110 accepts selection inputting of the favorite setting by the user can be employed.

Next, in step S1210, the client easy scan control unit 505 uses the client operation control unit 501 to display a scan preparation completion screen such as that illustrated in FIG. 10A on the output device of the client terminal 110. FIG. 10A illustrates an example of the scan preparation completion screen.

Next, in step S1211, the client easy scan control unit 505 checks, via the client FTP server control unit 504 and the client data storage unit 502, whether electronic data (file) output from the image processing apparatus 100 has been transmitted to a predetermined directory. Specifically, the client FTP server control unit 504 receives electronic data output from the image processing apparatus 100 with use of the FTP protocol via the client network control unit 503, and stores the received electronic data in a predetermined directory with use of the client data storage unit 502. Then, the client FTP server control unit 504 notifies the client easy scan control unit 505 that the reception of electronic data output from the image processing apparatus 100 has been completed. Upon receiving the completion notification from the client FTP server control unit 504, the client easy scan control unit 505 checks, via the client data storage unit 502, whether electronic data with a predetermined file name is currently stored in the predetermined directory. Furthermore, the predetermined name is a name generated according to a rule under which the name is made unique between the image processing apparatus 100 and the client terminal 110, as mentioned above with regard to step S816 illustrated in FIG. 8.

Here, if electronic data with the predetermined name is not currently stored in the predetermined directory, the client easy scan control unit 505 determines that electronic data (file) output from the image processing apparatus 100 has not been transmitted (NO in step S1211), and then advances the processing to step S1212.

In step S1212, since electronic data with the predetermined name is not currently stored in the predetermined directory, the client easy scan control unit 505 checks whether a previously designated timeout value for file transfer has been exceeded.

Here, if it is determined that the timeout value has not been exceeded (NO in step S1212), the client easy scan control unit 505 returns the processing to step S1211, in which the client easy scan control unit 505 checks again whether electronic data transmitted from the image processing apparatus 100 has been stored in the predetermined directory.

On the other hand, if it is determined that the timeout value has been exceeded (YES in step S1212), the client easy scan control unit 505 advances the processing to step S1213.

In step S1213, since electronic data has not been able to be transmitted from the image processing apparatus 100 within the designated time, the client easy scan control unit 505 uses the client operation control unit 501 to display an error screen for transmission failure. FIG. 13B illustrates an example of the transmission failure error screen. To end the processing after displaying of the transmission failure error screen, the client easy scan control unit 505 advances the processing to step S1215, in which the client easy scan control unit 505 performs end processing for the FTP server.

Moreover, if, in the above-mentioned step S1211, electronic data with the predetermined name is currently stored in the predetermined directory, the client easy scan control unit 505 determines that electronic data (file) output from the image processing apparatus 100 has been transmitted (YES in step S1211), and then advances the processing to step S1214.

In step S1214, since electronic data transmitted from the image processing apparatus 100 is currently stored with the predetermined file name in the predetermined directory, the client easy scan control unit 505 uses the client operation control unit 501 to display a scan completion (file reception) screen such as that illustrated in FIG. 10B on the output device of the client terminal 110. FIG. 10B illustrates an example of the scan completion (file reception) screen, which has been mentioned above with regard to step S819 illustrated in FIG. 8, and, therefore, the detailed description of the scan completion (file reception) screen is omitted here. After displaying the scan completion (file reception) screen, the client easy scan control unit 505 advances the processing to step S1215.

In step S1215, the client easy scan control unit 505 ends the FTP server function. Specifically, the client easy scan control unit 505 instructs the client FTP server control unit 504 to end the FTP server, thus stopping the FTP server function. After ending the FTP server function, the client easy scan control unit 505 advances the processing to step S1216.

In step S1216, the client easy scan control unit 505 performs, via the client network control unit 503, disconnection processing for the image processing apparatus 100. In the disconnection processing for the image processing apparatus 100, the client easy scan control unit 505 performs processing operations on the side of the client terminal 110 in step S821 to step S823 illustrated in FIG. 8, thus performing disconnection between the image processing apparatus 100 and the client terminal 110. After the processing operation in step S1216, the client easy scan control unit 505 ends the processing in the present flowchart.

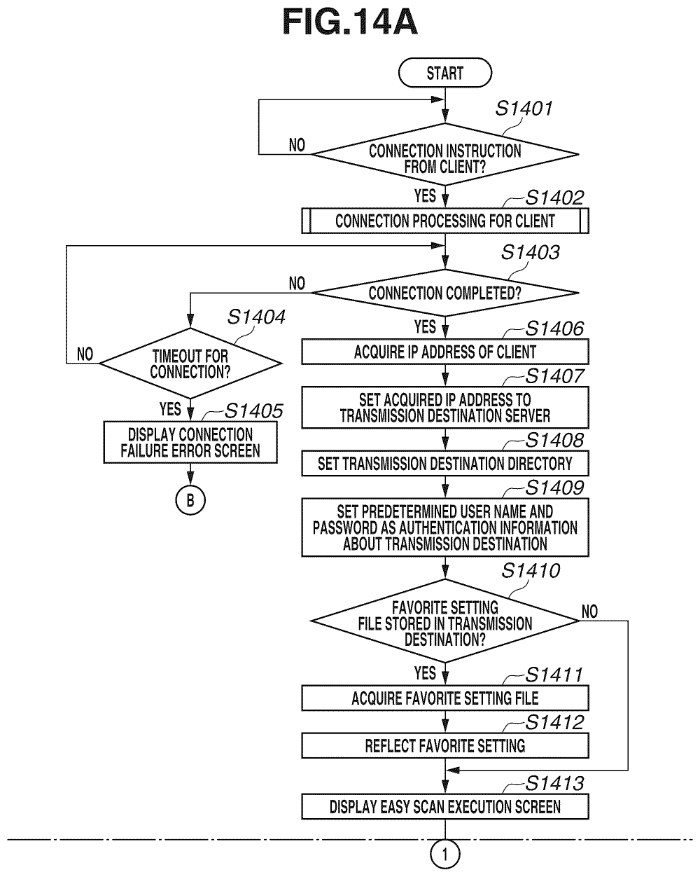

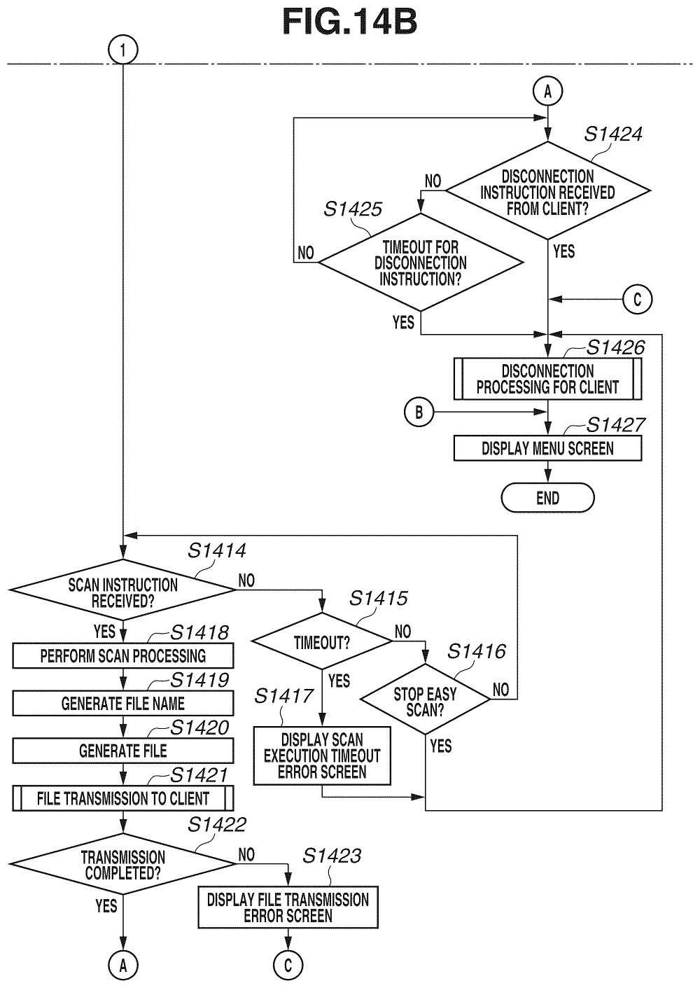

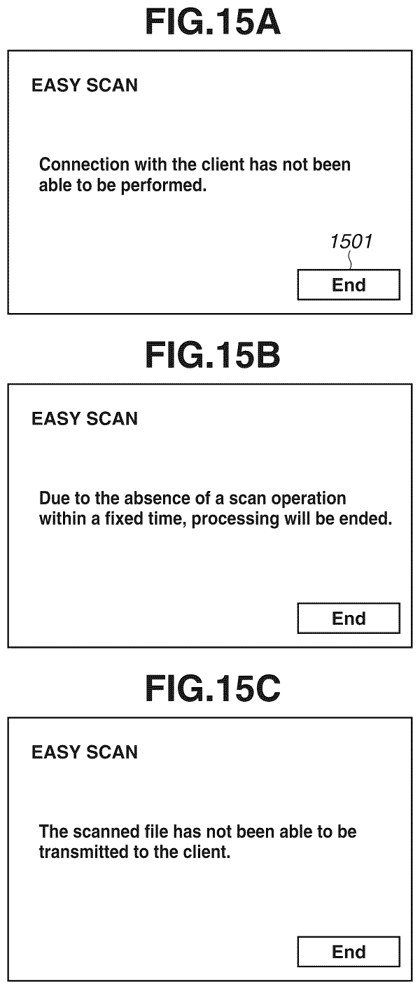

In the following description, processing which the image processing apparatus 100 performs in easy scan is described with reference to FIGS. 14A and 14B and FIGS. 15A, 15B, and 15C.

FIGS. 14A and 14B are flowcharts illustrating an example of processing which the image processing apparatus 100 performs in easy scan (processing in which the image processing apparatus 100 receives an instruction for easy scan start issued by the easy scan application 111 via the client terminal 110, performs scanning, and transmits a file to the client terminal 110) in the first exemplary embodiment. The processing illustrated in FIGS. 14A and 14B is performed by a function which is implemented by the CPU 201 reading out a program stored in the flash ROM 210 onto the DRAM 202 and executing the program.

FIGS. 15A to 15C are diagrams illustrating examples of error screens each of which is displayed in the image processing apparatus 100 in the first exemplary embodiment.

In response to the image processing apparatus 100 being started up, the processing in the flowcharts of FIGS. 14A and 14B is started.

In step S1401, the easy scan control unit 409 checks whether there is a connection instruction issued from the client terminal 110. Specifically, the easy scan control unit 409 inquires of the network control unit 407 and thus checks whether a connection request has come from the client terminal 110.

Here, if it is determined that no connection request has come from the client terminal 110 (NO in step S1401), the easy scan control unit 409 performs a processing operation in step S1401 again, thus checking again whether a connection request has come from the client terminal 110.

On the other hand, if it is determined that a connection request has come from the client terminal 110 (YES in step S1401), the easy scan control unit 409 advances the processing to step S1402.

In step S1402, the easy scan control unit 409 performs, via the network control unit 407, connection processing for connecting to the client terminal 110. In the connection processing for connecting to the client terminal 110, processing which is performed on the side of the image processing apparatus 100 in step S804 to step S806 illustrated in FIG. 8 is performed to establish a connection between the image processing apparatus 100 and the client terminal 110.

Next, in step S1403, the easy scan control unit 409 determines whether the connection with the client terminal 110 has been completed. Specifically, the easy scan control unit 409 checks whether the network control unit 407 has been able to connect to the client terminal 110.

Here, if it is determined that the connection with the client terminal 110 has not been completed (NO in step S1403), the easy scan control unit 409 advances the processing to step S1404.

In step S1404, the easy scan control unit 409 determines whether a timeout for connection has occurred. In this processing, a predetermined timeout time is previously set, and the easy scan control unit 409 determines whether the value of the predetermined timeout time has been exceeded.

Here, if it is determined that the timeout for connection has not occurred (NO in step S1404), the easy scan control unit 409 returns the processing to step S1403, in which the easy scan control unit 409 performs rechecking of the completion of connection with the client terminal 110.

On the other hand, if it is determined that the timeout for connection has occurred (YES in step S1404), the easy scan control unit 409 advances the processing to step S1405.

In step S1405, the easy scan control unit 409 uses the operation control unit 401 to display, on the operation unit 102, an error screen such as that illustrated in FIG. 15A indicating that the connection with the client terminal 110 has not been completed. FIG. 15A illustrates an example of the error screen. In response to an end button 1501 in the error screen being pressed, the network control unit 407 advances the processing to step S1427, in which the easy scan control unit 409 displays a menu screen (not illustrated) in the image processing apparatus 100.

Moreover, if, in the above-mentioned step S1403, it is determined that the connection with the client terminal 110 has been completed (YES in step S1403), the easy scan control unit 409 advances the processing to step S1406.

In step S1406, the easy scan control unit 409 acquires the IP address of the client terminal 110 the connection with which has been completed. Specifically, the easy scan control unit 409 inquiries about the IP address of the client terminal 110 connected to the network control unit 407.

Next, in step S1407, the easy scan control unit 409 sets the IP address acquired in the above-mentioned step S1406 as a transmission destination of the scanned electronic data. Specifically, the easy scan control unit 409 sets the IP address acquired in the above-mentioned step S1406 as a transmission destination in the FTP.

In step S1408, the easy scan control unit 409 sets a directory of the storage destination of the scanned electronic data in the client terminal 110. The directory of the storage destination is a directory preliminarily determined by the image processing apparatus 100 and the client terminal 110, and is, for example, a top directory of the FTP server of the client terminal 110. As mentioned above with regard to step S817 illustrated in FIG. 8, instead of transmitting the scanned file to a top directory of the FTP server of the client terminal 110, the image processing apparatus 100 can transmit the scanned file to a directory of, for example, the date at which the connection with the client terminal 110 was performed, or can transmit the scanned file to another directory.

Next, in step S1409, the easy scan control unit 409 sets authentication information for use in performing communication with the client terminal 110 (i.e., information for enabling data transmission with the client terminal 110 set as a destination). The authentication information includes a user name and a password, which are, for example, the ones which are used in common between the image processing apparatus 100 and the client terminal 110 with use of, for example, the method described above with regard to step S811 illustrated in FIG. 8. Furthermore, the easy scan control unit 409 can receive the IP address of the client terminal 110 and, for example, the above-mentioned user name and password from the client terminal 110 via the network control unit 407 and set the received IP address, user name, and password. Furthermore, while, in the first exemplary embodiment, since an example in which the FTP is used as a protocol for file transmission is described, a user name and a password are used as authentication information, in the case of using another protocol, the image processing apparatus 100 can use another type of authentication information according to the protocol in use.

Next, in step S1410, the easy scan control unit 409 accesses the directory of the storage destination of the client terminal 110 set in the above-mentioned step S1408 and determines whether a favorite setting file which is used at the time of scan settings is currently stored in the accessed directory. At this time, the easy scan control unit 409 determines whether there is a file with a file format preliminarily determined in such a way as to be recognizable as a favorite setting file in the directory, but can perform such determination with a method using another protocol. Moreover, the storage space of the favorite setting file can be designated separately from the directory of the storage destination set in the above-mentioned step S1408.

Here, if it is determined that the favorite setting file is currently stored (YES in step S1410), the easy scan control unit 409 advances the processing to step S1411.

In step S1411, the easy scan control unit 409 acquires a favorite setting file from the directory set in the above-mentioned step S1408.

Next, in step S1412, the easy scan control unit 409 acquires scan settings from the favorite setting file acquired in the above-mentioned step S1411, and reflects the favorite setting in the scan settings. At this time, a case where a setting which is unable to be applied due to the performance of the image processing apparatus 100 is included in the designated favorite setting is conceivable. For example, the inapplicable setting is a setting for detecting a blank page and automatically skipping the detected blank page. In a case where there is such an inapplicable setting, the easy scan control unit 409 causes a default setting to be reflected in the corresponding setting value. Moreover, at this time, although not illustrated, the easy scan control unit 409 can display a message indicating that the setting value is unable to be reflected in the scan settings on the operation unit 102 of the image processing apparatus 100.

Then, after the processing operation in step S1412, the easy scan control unit 409 advances the processing to step S1413.

Moreover, if, in the above-mentioned step S1410, it is determined that there is no favorite setting file (NO in step S1410), the easy scan control unit 409 advances the processing to step S1413.

In step S1413, the easy scan control unit 409 instructs the operation control unit 401 to display an easy scan execution screen 1100 such as that illustrated in FIG. 11A on the operation unit 102.

Next, in step S1414, the easy scan control unit 409 inquires of the operation control unit 401 and checks whether an instruction for scanning has been received. Specifically, the operation control unit 401 performs such determination by detecting whether the scan start button 1102 has been pressed.

Here, if it is determined that a scan instruction has not been received (NO in step S1414), the easy scan control unit 409 advances the processing to step S1415.

In step S1415, the easy scan control unit 409 checks whether, without scanning being performed, a designated time has passed and a timeout has occurred. This is performed to check whether the user has caused the client terminal 110 to connect to the image processing apparatus 100 but has left the image processing apparatus 100 unattended without performing scanning.

Here, if it is determined that no timeout has occurred (NO in step S1415), the easy scan control unit 409 advances the processing to step S1416.

In step S1416, the easy scan control unit 409 checks, via the operation control unit 401, whether the stop button 1104 has been pressed.

Here, if it is determined that the stop button 1104 has not been pressed (NO in step S1416), the easy scan control unit 409 returns the processing to step S1414, in which the easy scan control unit 409 checks again whether a scan instruction has been received.

On the other hand, if it is determined that the stop button 1104 has been pressed (YES in step S1416), since the user has issued an instruction for ending processing for easy scan, to end the processing, the easy scan control unit 409 advances the processing to step S1426, in which the easy scan control unit 409 performs processing for discarding a connection with the client terminal 110.

Moreover, if, in the above-mentioned step S1415, it is determined that a timeout has occurred (YES in step S1415), the easy scan control unit 409 advances the processing to step S1417.

In step S1417, the easy scan control unit 409 instructs the operation control unit 401 to display a scan execution timeout error screen such as that illustrated in FIG. 15B on the operation unit 102. FIG. 15B illustrates an example of the scan execution timeout error screen. After the processing operation in step S1417, the easy scan control unit 409 advances the processing to step S1426, in which the easy scan control unit 409 performs processing for discarding a connection with the client terminal 110.

Moreover, if, in the above-mentioned step S1414, it is determined that a scan instruction has been received (YES in step S1414), the easy scan control unit 409 advances the processing to step S1418. Furthermore, while, in the first exemplary embodiment, for ease of explanation, processing for changing setting values concerning scanning mentioned in step S813 illustrated in FIG. 8 is not illustrated, the following configuration can be employed. Before being instructed to perform scanning in the above-mentioned step S1413, the easy scan control unit 409 can determine whether the setting change button 1103 has been pressed and thus perform processing for changing settings concerning scanning.

In step S1418, the easy scan control unit 409 performs scan processing.

Specifically, the easy scan control unit 409 issues a scan job to the job control unit 403, and the job control unit 403 performs scanning of an original with use of the reading processing unit 406 and thus generates electronic data. However, the electronic data generated at this point of time is specific device-dependent data and is still not data of the format which can be universally handled. Furthermore, in the case of performing scanning with use of an ADF, in the scan processing, the easy scan control unit 409 sequentially reads originals set on the ADF and, after reading of all of the originals set on the ADF ends, the easy scan control unit 409 completes the scan processing. Moreover, in the case of performing scanning with an original placed on a platen glass, in the scan processing, each time reading of one original is complete, the easy scan control unit 409 displays, on the operation unit 102, a screen for receiving an instruction from the user for selecting whether to read a next original or end scanning. Then, in response to an instruction from the user for reading a next original, the easy scan control unit 409 performs reading of an original, and, in response to an instruction from the user for ending scanning, the easy scan control unit 409 completes scan processing. Additionally, in a case where “two-sided” is currently set as scan settings, the easy scan control unit 409 reads two sides of an original, and, in a case where “pasting together of images” is set as scan settings, the easy scan control unit 409 performs control to perform reading a number of times corresponding to the number of image portions to be pasted together with respect to one original.

Next, in step S1419, the easy scan control unit 409 generates a file name which is to be transmitted to the client terminal 110. As mentioned above with regard to step S816 illustrated in FIG. 8, the file name can be a unique name generated based on the date and time at which scanning was performed, or can be a name acquired from a result of optical character recognition (OCR). Furthermore, in the first exemplary embodiment, the scanned electronic data is of the multi-page format such as PDF or Tag Image File Format (TIFF) as an example, but can be of the single-page format such as JPEG. If the scanned electronic data is of the single-page format, the easy scan control unit 409 can generate a unique file name by, for example, adding a numerical value indicating a page number to the tail end of a file name generated by the method mentioned above in step S816 illustrated in FIG. 8.

Next, in step S1420, the easy scan control unit 409 generates a file to be transmitted to the client terminal 110, with the file name generated in the above-mentioned step S1419 according to the setting of a file format in the scan settings 1101. Specifically, the job control unit 403 instructs the image processing unit 404 to convert the scanned electronic data into a desired image format. After that, the data storage unit 402 stores the electronic data converted into the desired image format in a storage region of the image processing apparatus 100.

Next, in step S1421, the easy scan control unit 409 transmits the file generated in the above-mentioned step S1420 to the client terminal 110. Specifically, the easy scan control unit 409 instructs the network control unit 407 to extract the electronic data stored in the data storage unit 402 and perform file transmission of the electronic data by communicating with the client terminal 110 with the FTP protocol. Furthermore, in the description of the first exemplary embodiment, for example, negotiation or authentication in the FTP is a known technique and is not the gist of the first exemplary embodiment and is, therefore, omitted from description, but, naturally, is performed to enable file transmission in the FTP.

Next, in step S1422, the easy scan control unit 409 checks whether the scanned electronic data has been able to be transmitted to the client terminal 110. Specifically, the easy scan control unit 409 checks, via the network control unit 407, whether all of the pieces of desired file data have been able to be transmitted to the client terminal 110.

Here, if it is determined that the scanned electronic data has not been able to be transmitted due to, for example, a network trouble (NO in step S1422), the easy scan control unit 409 advances the processing to step S1423.

In step S1423, the easy scan control unit 409 uses the operation control unit 401 to display a file transmission error screen such as that illustrated in FIG. 15C on the operation unit 102. FIG. 15C illustrates an example of the file transmission error screen. After the processing operation in step S1423, the easy scan control unit 409 advances the processing to step S1426.

Moreover, if, in the above-mentioned step S1422, it is determined that the scanned electronic data has been able to be transmitted (YES in step S1422), the easy scan control unit 409 advances the processing to step S1424.

In step S1424, the easy scan control unit 409 checks whether a disconnection instruction has been received from the client terminal 110. This is performed to check whether disconnection processing for the image processing apparatus 100 has been performed by the client terminal 110 in step S1216 illustrated in FIG. 12 and a disconnection instruction has come to the image processing apparatus 100. Specifically, the easy scan control unit 409 inquires of the network control unit 407 and checks the presence or absence of a disconnection instruction from the client terminal 110.

Here, if it is determined that there is no disconnection instruction from the client terminal 110 (NO in step S1424), the easy scan control unit 409 advances the processing to step S1425.

In step S1425, the easy scan control unit 409 checks whether a timeout has occurred because, after the transmission of the scanned electronic data to the client terminal 110, a disconnection instruction from the client terminal 110 has not come in a designated time.

Here, if it is determined that a timeout has not occurred (NO in step S1425), the easy scan control unit 409 returns the processing to step S1424, in which the easy scan control unit 409 checks a disconnection instruction from the client terminal 110 again.

On the other hand, if it is determined that a timeout has occurred (YES in step S1425), the easy scan control unit 409 advances the processing to step S1426, in which the easy scan control unit 409 performs disconnection processing for the client terminal 110.

Moreover, if, in the above-mentioned step S1424, it is determined that there is a disconnection instruction from the client terminal 110 (YES in step S1424), the easy scan control unit 409 advances the processing to step S1426.

In step S1426, the easy scan control unit 409 performs disconnection processing for the client terminal 110 via the network control unit 407. In the disconnection processing for the client terminal 110, processing which is performed on the side of the image processing apparatus 100 in step S821 to step S823 illustrated in FIG. 8 is performed to perform disconnection between the image processing apparatus 100 and the client terminal 110. Furthermore, for example, in a case where, after a timeout has occurred in the above-mentioned step S1425, there is no disconnection instruction from the client terminal 110, the image processing apparatus 100 forcibly discards a connection with the client terminal 110. After the processing operation in step S1426, the easy scan control unit 409 advances the processing to step S1427.

In step S1427, to end the easy scan function and release the image processing apparatus 100 to another user, the easy scan control unit 409 instructs the operation control unit 401 to display a menu screen (not illustrated) for enabling, for example, copying or facsimile (FAX) on the operation unit 102.

Furthermore, while, after step S1427, the easy scan control unit 409 once ends the processing in the present flowchart, the processing in the present flowchart is performed again and, in step S1401, the easy scan control unit 409 waits for receiving a next request from the client terminal 110.

With the above-described processing, at the time of use of an easy scan application, by passing a favorite setting to the image processing apparatus 100, settings other than a destination also become already registered at the time of use of easy scan, and scan transmission easily becomes available by only one execution button. Thus, even in the environment of an image processing apparatus which the user uses for the first time, the user only issuing, via the client terminal 110, an instruction for scanning to the image processing apparatus 100 enables performing settings for transmitting scanned data between the client terminal 110 and the image processing apparatus 100. Moreover, the user preliminarily selecting, via the client terminal 110, a favorite setting to be used eliminates the need for an operation for scan settings in the image processing apparatus 100. Therefore, it becomes possible to more easily perform scanning which is performed in, for example, routine work, while reducing the trouble of operation and preventing or reducing setting errors, and transmit data to the client terminal 110. Therefore, even in the environment of an image processing apparatus which the user uses for the first time, it becomes possible to perform scanning which is performed in, for example, routine work, with an easiness equivalent to that in a case where scanning is performed in a usual environment, so that usability in scan processing can be dramatically improved.

In the above-described first exemplary embodiment, an example in which a favorite setting designated by the client terminal 110 is applied to the image processing apparatus 100 or is not changed after being applied thereto has been described. In a second exemplary embodiment of the present disclosure, a configuration in which, in the image processing apparatus 100, in a case where a favorite setting designated by the client terminal 110 has been changed, the changed favorite setting is able to be stored in the client terminal 110, so that changing of the favorite setting at the next and subsequent times can be omitted, is described.

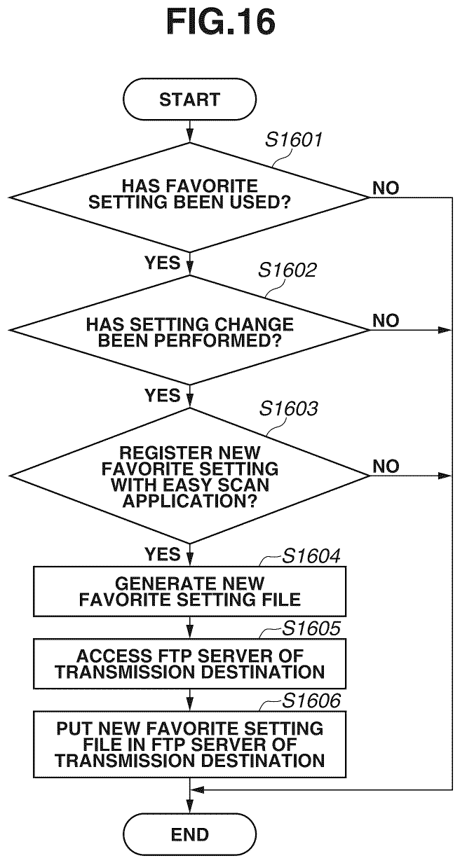

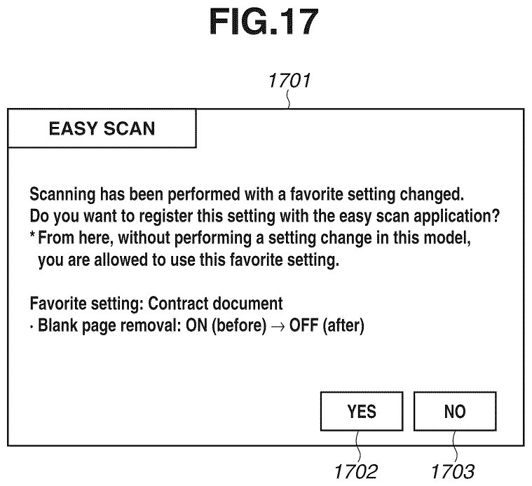

In the following description, processing which the image processing apparatus 100 performs in easy scan in the second exemplary embodiment is described with reference to FIG. 16 and FIG. 17.

FIG. 16 is a flowchart illustrating an example of processing which the image processing apparatus 100 performs in easy scan (processing in which, after the completion of file transmission in step S1422, the easy scan control unit 409 determines changing of the favorite setting, generates a new favorite setting file, and passes the generated favorite setting file to the client terminal 110) in the second exemplary embodiment. The processing illustrated in FIG. 16 is performed by a function which is implemented by the CPU 201 reading out a program stored in the flash ROM 210 onto the DRAM 202 and executing the program.

FIG. 17 is a diagram illustrating an example of a favorite setting change screen which is displayed in the image processing apparatus 100 in the second exemplary embodiment.

Furthermore, the processing illustrated in FIG. 16 is performed before the disconnection processing for the client terminal 110 performed in step S1426 illustrated in FIG. 14B.

In step S1601, the easy scan control unit 409 determines whether a favorite setting has been used. Specifically, the easy scan control unit 409 performs such determination by checking whether a favorite setting file has been acquired in step S1411 illustrated in FIG. 14A.

Here, if it is determined that no favorite setting has been used (NO in step S1601), the easy scan control unit 409 ends the processing in the present flowchart.

On the other hand, if it is determined that a favorite setting has been used (YES in step S1601), the easy scan control unit 409 advances the processing to step S1602.

In step S1602, the easy scan control unit 409 determines whether the applied favorite setting has been changed. Specifically, the easy scan control unit 409 performs such determination by checking whether, in step S1413 illustrated in FIG. 14A, the setting change button 1103 has been pressed so that the settings have been changed. Moreover, in a case where, as mentioned above with regard to step S1412 illustrated in FIG. 14A, the favorite setting is unable to be applied due to a certain setting value and, therefore, a default setting value has been set, the easy scan control unit 409 also determines that the favorite setting has been changed.

Here, if it is determined that the favorite setting has not been changed (NO in step S1602), the easy scan control unit 409 ends the processing in the present flowchart. On the other hand, if it is determined that the favorite setting has been changed (YES in step S1602), the easy scan control unit 409 advances the processing to step S1603.

In step S1603, the easy scan control unit 409 determines whether to register a new favorite setting with the easy scan application 111. Specifically, the easy scan control unit 409 performs such determination by displaying a favorite setting change screen 1701 such as that illustrated in FIG. 17 on the operation unit 102 and checking whether a YES button 1702 or a NO button 1703 has been pressed.

Here, if it is determined that the NO button 1703 has been pressed, the easy scan control unit 409 determines not to register the new favorite setting (NO in step S1603), and then ends the processing in the present flowchart.

On the other hand, if it is determined that the YES button 1702 has been pressed, the easy scan control unit 409 determines to register the new favorite setting (YES in step S1603), the easy scan control unit 409 advances the processing to step S1604.

In step S1604, the easy scan control unit 409 generates a new favorite setting file. Specifically, the easy scan control unit 409 duplicates the favorite setting file acquired in step S1411 illustrated in FIG. 14A, and changes, from the duplicated setting file, only the scan settings determined to have been changed in the above-mentioned step S1602. In the example illustrated in FIG. 17, the setting of blank page removal is changed from ON to OFF. Moreover, to expressly indicate that the new favorite setting file is a favorite setting file different from the applied favorite setting file, the easy scan control unit 409 optionally sets the name of the favorite setting. At this time, in a case where the reason why this setting change has been performed is because a part of the favorite setting intended to be applied has been unable to be applied due to the performance of the image processing apparatus 100, it is hoped to show that the new favorite setting is intended for the image processing apparatus 100. Therefore, appending, for example, a model name, a version or a serial code to the tail end of the name of the favorite setting enables discriminating between the respective favorite settings to be used at the next and subsequent times. A new favorite setting file can be generated by, for example, using a naming method other than the above-mentioned method or additionally appending an installation location of the image processing apparatus 100. Moreover, a software keyboard can be displayed on the operation unit 102 of the image processing apparatus 100 and be operated by the user to change the name of the original favorite setting file for the purpose of performing the above-mentioned processing.

Next, in step S1605, the easy scan control unit 409 accesses the directory of the transmission destination to which the image processing apparatus 100 has transmitted the image file in step S817 illustrated in FIG. 8.

Next, in step S1606, the easy scan control unit 409 puts the new favorite setting file generated in the above-mentioned step S1604 in the directory which the easy scan control unit 409 has accessed in the above-mentioned step S1605, and then ends the processing in the present flowchart.

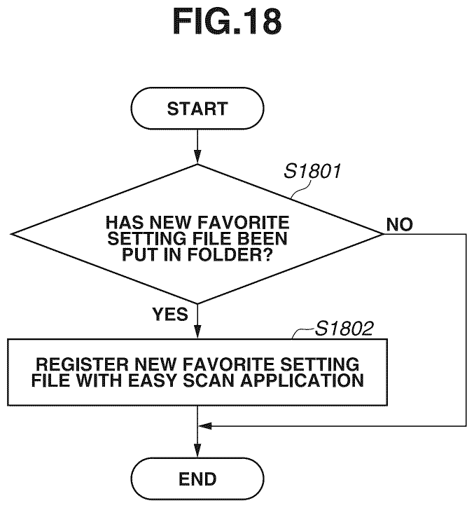

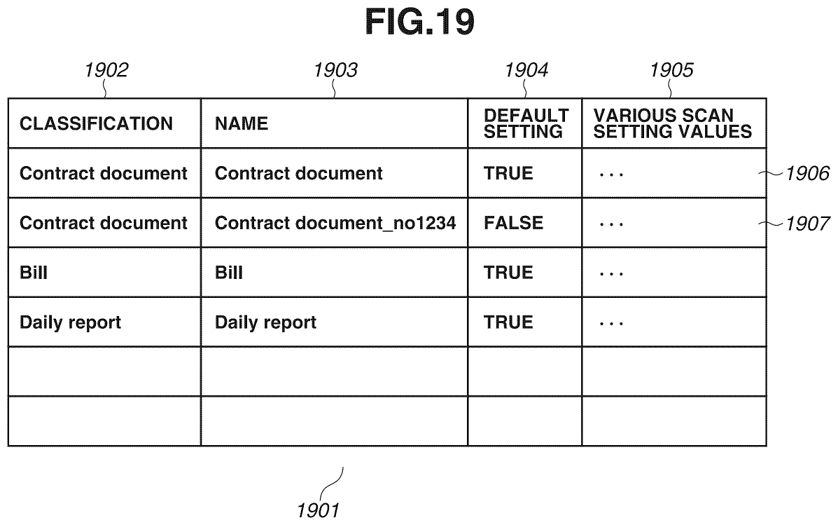

In the following description, processing which the client terminal 110 performs in easy scan in the second exemplary embodiment is described with reference to FIG. 18 and FIG. 19.

FIG. 18 is a flowchart illustrating an example of processing which the client terminal 110 performs in easy scan (processing in which, after the completion of reception of a file in step S1211, the easy scan application 111 registers a new favorite setting file transmitted from the image processing apparatus 100) in the second exemplary embodiment. The processing illustrated in FIG. 18 is performed by a function which is implemented by the CPU 301 reading out a program stored in the HDD 306 onto the DRAM 302 and executing the program.

FIG. 19 is a diagram illustrating an example of a list of favorite setting files registered with the client terminal 110 in the second exemplary embodiment.

The processing illustrated in FIG. 18 is performed prior to the end processing for the FTP server performed in step S1215 illustrated in FIG. 12.

In step S1801, the easy scan application 111 determines whether a new favorite setting file has been put in an optional directory of the FTP server. The easy scan application 111 performs such determination by, for example, referring to creation times of files or favorite setting files retained in the easy scan application 111 and checking whether there is a favorite setting file which is not present in the referred-to files. Naturally, the easy scan application 111 can perform such determination by using another method.

Here, if it is determined that there is no new favorite setting file (NO in step S1801), the easy scan application 111 ends the processing in the present flowchart.

On the other hand, if it is determined that there is a new favorite setting file (YES in step S1801), the easy scan application 111 advances the processing to step S1802.

In step S1802, the easy scan application 111 registers the new favorite setting file with the easy scan application 111 itself. In the following description, such a registration operation is specifically described with reference to FIG. 19.

For example, it is assumed that a table 1901 of favorite setting files such as that illustrated in FIG. 19 is retained in the easy scan application 111. The “classification” column 1902 indicates a classification name for classifying a favorite setting file. The “name” column 1903 indicates the name of a favorite setting file.

The “default setting” column 1904 indicates whether, when there is a plurality of favorite setting files with the same classification, the favorite setting file concerned is a favorite setting file designated by default. With regard to a default value to be used here, a favorite setting which has been registered by the corresponding classification 1902 for the first time is set to “TRUE”, but, when the number of favorite settings of the same classification 1902 has increased, the default value can be edited by the easy scan application 111. Moreover, in a case where, at the time of registration of a favorite setting, there are overlapping favorite settings of the same classification 1902, which of the favorite settings is to be set as a default setting can be designated by the easy scan application 111. However, with respect to one classification, one default setting has to be present. Therefore, in a case where only one favorite setting is present with respect to one classification, such a favorite setting is necessarily set as a default setting for that classification.

The “various scan setting values” column 1905 indicates various scan setting values in the respective files. For example, it is assumed that, at first, a favorite setting file with the classification “contract document”, the name “contract document”, and the default setting “TRUE” such as a favorite setting file 1906 is previously registered. In step S1412 illustrated in FIG. 14A, the favorite setting file 1906 is applied to the image processing apparatus 100. A new favorite setting file subjected to the setting change generated by the easy scan control unit 409 of the image processing apparatus 100 in step S1604 illustrated in FIG. 16 is acquired via the FTP server. At this time, the easy scan application 111 newly registers the new favorite setting file with a portion of the “default setting” column 1904 set to “FALSE” such as a favorite setting file 1907. The name in the “name” column 1903 of the new favorite setting file 1907 is generated in step S1604 illustrated in FIG. 16 in such a manner that identification information is appended to the tail end of the original name “contract document” such as “contract document_no1234” for facilitating discrimination of models.

In the above-described way, the new favorite setting file is registered with the easy scan application 111. Then, after registration processing in the above-mentioned step S1802, the easy scan application 111 ends the processing in the present flowchart.

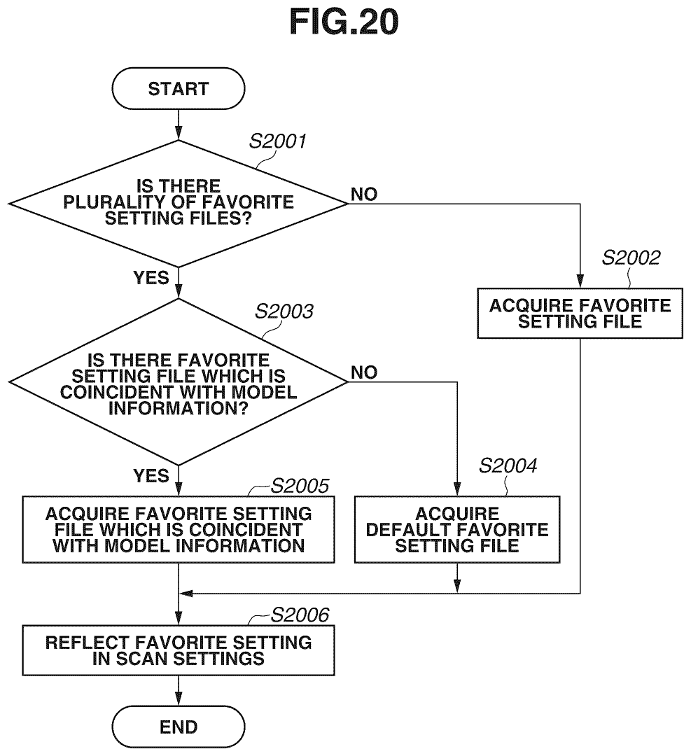

Here, processing which the image processing apparatus 100 performs at the time of scan setting reflection in easy scan in the second exemplary embodiment is described with reference to FIG. 20.

While, in the first exemplary embodiment, an example in which the number of favorite settings which are selected in the same classification 1902 is fixed to one has been described, in the second exemplary embodiment, a case where, in the same classification 1902, there is a plurality of favorite settings is described. The second exemplary embodiment differs from the first exemplary embodiment in that there is a logic for selecting a favorite setting which the image processing apparatus 100 handles from among a plurality of favorite settings.

FIG. 20 is a flowchart illustrating an example of processing which the image processing apparatus 100 performs in easy scan (processing which the easy scan control unit 409 performs in a case where there is a plurality of favorite setting files in step S1411) in the second exemplary embodiment. The processing illustrated in FIG. 20 is performed by a function which is implemented by the CPU 201 reading out a program stored in the flash ROM 210 onto the DRAM 202 and executing the program.

Furthermore, the processing illustrated in FIG. 20 is performed in step S1411 illustrated in FIG. 14A.

In step S2001, the easy scan control unit 409 determines whether there is a plurality of favorite setting files from the directory set in step S1408 illustrated in FIG. 14A.

Here, if it is determined that there is not a plurality of favorite setting files (NO in step S2001), the easy scan control unit 409 advances the processing to step S2002.

In step S2002, the easy scan control unit 409 performs the same processing as that performed in step S1411 illustrated in FIG. 14A (the description thereof being omitted here), and then advances the processing to step S2006.

On the other hand, if it is determined that there is a plurality of favorite setting files (YES in step S2001), the easy scan control unit 409 advances the processing to step S2003.

In step S2003, the easy scan control unit 409 determines whether there is a favorite setting file which is, for example, coincident with (related to) model information about the image processing apparatus 100. Specifically, the easy scan control unit 409 determines whether there is information available for discriminating the image processing apparatus 100 in a character string appended to a tail portion of the file name of the favorite setting file in step S1604. In that event, the easy scan control unit 409 can look for the file name from a plurality of files put in the directory or, in a case where a list of files such as that shown in the table 1901 is also put in the directory, the easy scan control unit 409 can look for the file name from the list.

Here, if it is determined that there is no favorite setting file which is coincident with the model information (NO in step S2003), the easy scan control unit 409 advances the processing to step S2004.

In step S2004, the easy scan control unit 409 acquires a favorite setting file the value of the “default setting” column 1904 is “TRUE” from among the favorite setting files put in the directory, and then advances the processing to step S2006.

On the other hand, if it is determined that there is a favorite setting file which is coincident with the model information (YES in step S2003), the easy scan control unit 409 advances the processing to step S2005.

In step S2005, the easy scan control unit 409 acquires the favorite setting file which is coincident with the model information, and then advances the processing to step S2006.

In step S2006, the easy scan control unit 409 acquires scan settings from the favorite setting file acquired in the above-mentioned step S2002, step S2004, or step S2005, and thus reflects the favorite setting in the scan settings.

A specific example of the above-mentioned flow is described with reference to a list of favorite setting files illustrated in FIG. 19.

For example, it is assumed that the user has selected a favorite setting for “contract document” via the easy scan application 111. In step S2001, the easy scan application 111 of the client terminal 110 looks for a setting file the value of the “classification” column 1902 of which is “contract document” from the favorite setting files such as those illustrated in FIG. 19. In the example illustrated in FIG. 19, the setting file to be looked for corresponds to the setting files 1906 and 1907. Thus, in this case, a plurality of favorite settings is specified in response to a user instruction in the favorite setting list screen 903. Next, the easy scan application 111 stores favorite setting files corresponding to the above-mentioned setting files 1906 and 1907 in a predetermined directory.

In step S2001, when accessing the designated directory, the easy scan control unit 409 of the image processing apparatus 100 determines that there is a plurality of favorite setting files, i.e., favorite setting files 1906 and 1907, and then advances the processing to step S2003.

In step S2003, the easy scan control unit 409 compares the values of the “name” column 1903 of the favorite setting files 1906 and 1907 with identification information (here, assumed to be “no1234”) about the image processing apparatus 100. Since the value of the “name” column 1903 of the favorite setting file 1907 is “contract document_no1234”, so that a character string coincident with the identification information is included in the value of the “name” column 1903, the easy scan control unit 409 determines that the favorite setting file 1907 is a favorite setting file having coincidence in model information. If, here, it is determined that there is no favorite setting file having coincidence, the easy scan control unit 409 determines that the favorite setting file 1906, the value of the “default setting” column 1904 of which is “TRUE”, is a favorite setting file to be used.

In step S2005, the easy scan control unit 409 acquires the favorite setting file 1907, which has coincidence in model information, and, in step S2006, the easy scan control unit 409 reflects the favorite setting file 1907 in the scan settings.

The above-described processing enables, in a case where a designated favorite setting file has been changed by the easy scan control unit 409, applying the favorite setting file without performing an operation for changing scan settings at the next and subsequent times.

As described above, according to each exemplary embodiment, cumbersome scan settings in an image processing apparatus become unnecessary, and, even in the environment of an image processing apparatus which the user uses for the first time, it becomes possible to more easily perform scanning while reducing the trouble of operation and preventing or reducing setting errors. Therefore, even in the environment of an image processing apparatus which the user uses for the first time, it becomes possible to perform scanning which is performed in, for example, routine work, with an easiness equivalent to that in a case where scanning is performed in a usual environment, so that usability in scan processing can be dramatically improved.

Furthermore, the structures of the above-mentioned various pieces of data and the contents thereof are not limited to those described above, and, naturally, can be altered to various structures and contents according to use applications and purposes.

The present disclosure can be embodied as exemplary embodiments serving as, for example, a system, an apparatus, a method, a program, and a storage medium. Specifically, the present disclosure can be applied to a system composed of a plurality of pieces of equipment, or can be applied to an apparatus composed of one piece of equipment.

Moreover, all of the constituent elements obtained by combining the above-described exemplary embodiments can also be included in the present disclosure.

According to aspects of the present disclosure, cumbersome scan settings in an image processing apparatus become unnecessary, and, even in the environment of an image processing apparatus which the user uses for the first time, it becomes possible to more easily perform scanning while reducing the trouble of operation and preventing or reducing setting errors. Therefore, even in the environment of an image processing apparatus which the user uses for the first time, it becomes possible to perform scanning which is performed in, for example, routine work, with an easiness equivalent to that in a case where scanning is performed in a usual environment, so that usability in scan processing can be dramatically improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-085150 filed May 24, 2024, which is hereby incorporated by reference herein in its entirety.

What is claimed is:

1. An image processing apparatus including a scanner, the image processing apparatus comprising:
a connection unit configured to, in response to a connection request from an information processing apparatus which lies close to the image processing apparatus and which has an application for issuing an instruction to an image processing apparatus including a scanner installed thereon, establish a communication connection with the information processing apparatus;
a reception unit configured to receive, from the information processing apparatus, an instruction including scan settings which are managed by the application selected by a user in the information processing apparatus with which the communication connection has been established;
an acceptance unit configured to accept a user instruction for performing scan processing using the received scan settings; and
a processing unit configured to, in response to the user instruction being accepted, perform scan processing based on the scan settings and transmit data obtained by the scan processing to the information processing apparatus.

2. The image processing apparatus according to claim 1, wherein the processing unit transmits the data to the information processing apparatus with use of a destination corresponding to the information processing apparatus obtained by the communication connection.

3. The image processing apparatus according to claim 1, further comprising an output unit configured to output scan settings which are managed in the image processing apparatus as processable data to the application.

4. The image processing apparatus according to claim 1,
wherein the acceptance unit is able to accept a user instruction for changing scan settings received from the information processing apparatus and performing scan processing using the changed scan settings, and
wherein the image processing apparatus further comprises a transmission unit configured to, in a case where the scan settings have been changed by the user instruction, transmit the changed scan settings to the information processing apparatus.

5. The image processing apparatus according to claim 1, wherein, when having received a plurality of sets of scan settings from the information processing apparatus, the reception unit selects, from the plurality of sets of scan settings, scan settings with a name related to model information about the image processing apparatus.

6. A method for an image processing apparatus including a scanner, the method comprising:
in response to a connection request from an information processing apparatus which lies close to the image processing apparatus and which has an application for issuing an instruction to an image processing apparatus including a scanner installed thereon, establishing a communication connection with the information processing apparatus;
receiving, from the information processing apparatus, an instruction including scan settings which are managed by the application selected by a user in the information processing apparatus with which the communication connection has been established;
accepting a user instruction for performing scan processing using the received scan settings; and
in response to the user instruction being accepted, performing scan processing based on the scan settings and transmitting data obtained by the scan processing to the information processing apparatus.

7. A non-transitory computer-readable storage medium storing a computer program which, when executed by a computer, causes the computer to perform a method for an image processing apparatus including a scanner, the method comprising:
in response to a connection request from an information processing apparatus which lies close to the image processing apparatus and which has an application for issuing an instruction to an image processing apparatus including a scanner installed thereon, establishing a communication connection with the information processing apparatus;
receiving, from the information processing apparatus, an instruction including scan settings which are managed by the application selected by a user in the information processing apparatus with which the communication connection has been established;
accepting a user instruction for performing scan processing using the received scan settings; and
in response to the user instruction being accepted, performing scan processing based on the scan settings and transmitting data obtained by the scan processing to the information processing apparatus.
